(19) United States
(12) Patent Application Publication
(10) Pub. No.: US 2026/0336886 A1
(43) Pub. Date: Oct. 29, 2026

(54) MIXING CONTAINER FORMED FROM TWO IDENTICAL SHELLS WITH VENTING

(71) Applicant: Anchor Packaging, LLC, St. Louis, MO (US)

(72) Inventors: Michael A. Pohlman, Valley Park, MO (US); Michael B. Tyberghein, Roswell, GA (US); Michael Hanson, Augusta, MI (US)

(21) Appl. No.: 19/654,256

(22) Filed: Apr. 21, 2026

Related U.S. Application Data
(60) Provisional application No. 63/793,448, filed on Apr. 23, 2025.
(60) Provisional application No. 64/031,008, filed on Apr. 6, 2026.

(51) Int. Cl. B65D 51/16; B65D 1/26; B65D 21/02; B65D 43/02

(52) U.S. Cl. CPC B65D 51/1622; B65D 1/26; B65D 21/0233; B65D 43/0206; B65D 2217/00; B65D 2543/00092; B65D 2543/00351; B65D 2543/00462; B65D 2543/00657; B65D 2543/00768; B65D 2543/00842

(57) ABSTRACT

A container for manually mixing contents, when formed, has a first longitudinally horizontal axis A₁, a second laterally horizontal axis A₂, and a vertical axis A₃ that is perpendicular to the horizontal axes A₁ and A₂. The container includes a first shell and a second shell releasably engageable with the first shell when inverted relative to the first shell. The first shell and the second shell have a substantially identical profile. Each of the shells includes a cover portion, a rim, and a sidewall extending between the cover portion and the rim in a direction of the vertical axis A₃ and defining an interior of the shell. The rim defines an elliptic-shaped opening to the interior and the interior has two conjugate diameters D₁ and D₂ proximate the opening and two conjugate diameters D₃ and D₄ proximate the cover portion. The diameters D₁ and D₃ extend in a direction of the longitudinally horizontal axis A₁ and the diameters D₂ and D₄ extend in a direction of the laterally horizontal axis A₂. A ratio of D₁ to D₂ is greater than 1 and a ratio of D₃ to D₄ is greater than 1.

### CROSS-REFERENCE TO RELATED APPLICATIONS

This application claims priority to U.S. Provisional Patent Application No. 63/793,448, filed Apr. 23, 2025, and U.S. Provisional Patent Application No. 64/031,008, filed Apr. 6, 2026, the disclosure of which are hereby incorporated herein by reference in their entireties.

### BACKGROUND

The field of the disclosure relates generally to mixing containers and, more particularly, to containers that are used to manually mix contents stored therein and provide venting of heated vapors or gases from within the containers.

Containers are frequently used to store and/or transport components and to mix the components therein. In food applications, containers may be used by a user to mix different food items prior to consumption, and the mixed food items can then be stored and/or transported in the same container without having to transfer the food items to another receptacle. For example, a salad and dressing mixture or a sauce and chicken wings mixture may be manually mixed within a container by a user to obtain a desired heterogenous distribution of the ingredients prior to consumption and then consumed from the container, transported to another location, or stored for later use.

Some known food storage containers are specifically designed for mixing food items therein. Oftentimes, the design attempts to increase an interior volume of the container to provide more room for the contents to move during mixing. However, this typically results in an oversizing and larger footprint of the container, which is undesired for the storage and transportation functionality and for inventory storage of the container prior to use. Larger size containers also have greater material and/or manufacturing costs. There is an ongoing need for improvements in the manufacturability and/or design of such containers that reduce the footprint of the container while still allowing for suitable mixing therein, reduce costs, improve the durability of the container, and/or improve the usability of the container.

Food storage containers also typically include a base and a lid that have different profiles and configurations based on the desired use of the container. Containers that include different bases and lids create a significant volume footprint for establishments that are often limited in space. The different bases and lids also create an inventory burden as it is difficult to track the different bases and lids to ensure that an equal ratio of lids to bases are available. The number of containers available for use may be depleted when lids or bases required to complete a container are damaged or otherwise removed from the pool of bases or lids. The footprint and inventory burdens are exacerbated by the fact that establishment frequently package foods in differently sized and/or shaped containers. Accordingly, it would be desirable to reduce storage space and optimize inventory through the use of more convenient packaging material.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. These statements are to be read in this light, and not as admissions of prior art.

### BRIEF DESCRIPTION

In one aspect, a container for manually mixing contents stored therein is provided. The container, when formed, has a first longitudinally horizontal axis A₁, a second laterally horizontal axis A₂, and a vertical axis A₃ that is perpendicular to the horizontal axes A₁ and A₂. The container includes a first shell and a second shell releasably engageable with the first shell when inverted relative to the first shell. The first shell and the second shell have a substantially identical profile. Each of the first and second shells includes a cover portion, a rim, and a sidewall extending between the cover portion and the rim in a direction of the vertical axis A₃ and defining an interior of the shell. The rim defines an elliptic-shaped opening to the interior and the interior has two conjugate diameters D₁ and D₂ proximate the opening and two conjugate diameters D₃ and D₄ proximate the cover portion. The diameters D₁ and D₃ extend in a direction of the longitudinally horizontal axis A₁ and the diameters D₂ and D₄ extend in a direction of the laterally horizontal axis A₂. A ratio of D₁ to D₂ is greater than 1 and a ratio of D₃ to D₄ is greater than 1.

In another embodiment, a method of mixing contents using the above-referenced container is provided. The method includes placing the contents within the base chamber, forming the container by engaging the rims of the first shell and the second shell inverted relative to the first shell to enclose the contents within the base and lid chambers, and manually mixing the contents by rotating the container about the laterally horizontal axis A₂. During rotation of the container the contents reciprocate between the base and lid chambers and are centered relative to a plane defined by the longitudinally horizontal axis A₁ and the vertical axis A₃ such that the contents are substantially mixed without rotating the container in another direction.

In yet another embodiment, a shell for forming using the above-referenced container when engaged with another shell having a substantially identical profile and inverted relative to the shell is provided. The shell includes a cover portion, a circular rim, and a sidewall extending between the cover portion and the rim in a direction of the vertical axis A₃ and defining an interior of the shell, wherein the rim defines an elliptic-shaped opening to the interior, wherein the interior has two conjugate diameters D₁ and D₂ proximate the opening and two conjugate diameters D₃ and D₄ proximate the cover portion, wherein the diameters D₁ and D₃ extend in a direction of the longitudinally horizontal axis A₁ and the diameters D₂ and D₄ extend in a direction of the laterally horizontal axis A₂, and wherein a ratio of D₁ to D₂ is greater than 1 and a ratio of D₃ to D₄ is greater than 1.

In another aspect, a container for manually mixing contents stored therein with venting features is provided. The container with venting features is configured to mix the contents stored therein including solid products with heated liquids that produce vapors or gases during mixing that are appropriately vented through the venting features to maintain the closure of the container and prevent the lid from popping off due to the build-up of pressure within the container.

In yet another aspect a container for manually mixing contents therein is provided. The container includes a first shell and a second shell releasably engageable with the first shell when inverted relative to the first shell, wherein the first shell and the second shell have a substantially identical profile. Each of the first and second shells include a cover portion, a rim, and a sidewall extending between the cover portion and the rim. The rim includes a proximal segment extending outwardly from the sidewall, a bead segment extending outwardly from the proximal segment, and at least one vent channel defined in the bead segment. The at least one vent channel extends radially in the bead segment to enable venting of the container through at least one vent path defined by the at least one vent channels of the first shell and the second shell. When the container is formed, the at least one vent path includes a constricting section and a flow section downstream of the constricting section. A height of the constricting section is less than a height of the flow section and the height of the flow section is greater than a height of the vent path downstream of the flow section.

### BRIEF DESCRIPTION OF THE DRAWINGS

FIG. 1 is a perspective view of an example container in a closed configuration.

FIG. 2 is a left side elevation of the container of FIG. 1.

FIG. 3 is right side elevation of the container of FIG. 1.

FIG. 4 is a rear elevation of the container of FIG. 1.

FIG. 5 is a front elevation of the container of FIG. 1.

FIG. 6 is a top plan view of the container of FIG. 1.

FIG. 7 is a bottom plan view of the container of FIG. 1.

FIG. 8 is a perspective view of the container of FIG. 1 in an open configuration.

FIG. 9 is an enlarged view of Box 9 in FIG. 5.

FIG. 10 is an enlarged view of Box 10 in FIG. 2.

FIG. 11 is a perspective view of one of two shells that have substantially identical profiles and are used to form the container of FIGS. 1-8.

FIG. 12 is a right side elevation of the shell of FIG. 11.

FIG. 13 is left side elevation of the shell of FIG. 11.

FIG. 14 is a rear elevation of the shell of FIG. 11.

FIG. 15 is a front elevation of the shell of FIG. 11.

FIG. 16 is a bottom plan view of the shell of FIG. 11.

FIG. 17 is a top plan view of the shell of FIG. 11.

FIG. 18 is a perspective view of a first alternative container in an open configuration.

FIG. 19 is a right side elevation of one of two shells that have substantially identical profiles and are used to form the container of FIG. 18.

FIG. 20 is a front elevation of the shell of FIG. 18.

FIG. 21 is a top plan view of the shell of FIG. 18.

FIG. 22 is a perspective view of a second alternative container in an open configuration.

FIG. 23 is a top plan view of one of two shells that have substantially identical profiles and are used to form the container of FIG. 22.

FIG. 24 is a perspective view of a third alternative container in an open configuration.

FIG. 25 is a perspective view of one of two shells that have substantially identical profiles and are used to form the container of FIG. 24.

FIG. 26 is a top plan view of the shell of FIG. 25.

FIG. 27 is an enlarged view of the shell of FIG. 25.

FIG. 28 is a perspective view of a fourth alternative container in an open configuration.

FIG. 29 is a top plan view of the container of FIG. 28.

FIG. 30 is a right side elevation of a shell of the container of FIG. 28.

FIG. 31 is a front elevation of the shell of FIG. 30.

FIG. 32 is a top plan view of the shell of FIG. 30.

FIG. 33 is an enlarged perspective view of the shell of FIG. 30.

FIG. 34 is a cross-section view of the container of FIG. 28, taken along the line 34 -34 in FIG. 29.

FIG. 35 is an enlarged cross-section view showing the region in FIG. 34.

FIG. 36 is an enlarged cross-section view showing the region in FIG. 34.

FIG. 37 is a cross-section view of the container of FIG. 28, taken along the line 37 -37 in FIG. 29.

FIG. 38 is a cross-section view of the container of FIG. 28, taken along the line 38 -38 in FIG. 29.

FIG. 39 is a cross-section view of the container of FIG. 28, taken along the line 39 -39 in FIG. 29.

FIG. 40 is an enlarged cross-section view showing the region 40 in FIG. 39.

Corresponding reference numerals used throughout the drawings indicate corresponding elements and components.

### DETAILED DESCRIPTION

Embodiments described herein relate to containers for storing and/or transporting contents (e.g., items of food) that can be used to manually mix the contents therein. The containers described herein are suitably used to mix multiple different food ingredients prior to consumption. In some examples the containers are used for applying a sauce, seasoning, or condiment to a food item or items, such as applying sauce and/or seasoning to chicken wings or mixing a salad with dressing. The containers are dimensioned to allow sufficient mixing of the contents therein by a user while reducing the amount of time and effort required to achieve sufficient mixing and also reducing the size and footprint of the container. The containers are sized and shaped to allow for a reduced amount of sauce and/or seasoning needed to achieve an even distribution of the sauce and/or seasoning on food products mixed within the containers.

In particular, examples of mixing containers described herein have an oblong or substantially frusto-ellipsoid and/or round shape and are formed by a lid and base each defining an elliptic opening and an interior volume (or interior). The interiors of the lid and base cooperate to define the interior volume, or mixing chamber, of the container in which mixing is performed. The elliptic openings of the lid and base have complementing conjugate diameters that are sized to facilitate centering the contents relative to a longitudinal plane while the container is rotated about a laterally horizontal axis. The interiors of the lid and the base also have a height such that, during rotation of the container, the contents reciprocate within the mixing chamber of the container between the base and lid interiors to achieve sufficient mixing. As a result, a user can avoid excessive time and/or effort to achieve sufficient mixing that is typically required when using containers that do not facilitate controlled and directional mixing (e.g., in circular mixing containers). Additionally, the interior volume can be relatively limited in size while still achieving sufficient mixing, thus facilitating reducing size and footprint of the container.

In various examples, the containers also include additional dimensional characteristics and/or features to improve the functionality and/or usability of the container. For example, the interiors of the lid and the base may have tapered diameters defined by curved sidewalls that enhance mixing efficiency (e.g., by limiting deviation from the center of the container during rotation) and promote downward pooling of the mixed contents for consumption. Grips may be provided on the periphery of the container at lateral sides thereof to allow a user to easily and comfortably rotate the container about the mixing axis (i.e., the laterally horizontal axis). Structural ribs may be included to allow the sidewalls to resist a downward force applied to close the container and enable the user to close and seal the container via the downward force without the sidewalls collapsing. The structural ribs may also be outwardly-extending and tapered, with a reduced surface area at terminal contact points that allow a user to handle the container while minimizing exposure to heat from contents (e.g., hot food items) stored therein.

Embodiments described herein also relate to mixing containers formed from a pair of shells having a substantially identical profile. One of the shells defines the base of the container and the other shell defines the lid of the container. As used herein, the phrase “substantially identical profile” refers to a same overall footprint and outer profile. As such, the shells can be alternately or interchangeably used as the base and lid of the container. The shell that defines the base and the shell that defines the lid may change depending on the orientation of the container (e.g., when flipped or inverted 180 °).

Shells having a substantially identical profile may have some differences. For example, shells that have different depths or shells that have different contours or areas of curvature at discrete regions may have a substantially identical profile. Shells having a substantially identical profile may have the same elements and components (e.g., denesting features, stacking features, venting features, etc.) at different locations.

As used herein, the term “shell” refers to a shell component of a container that may be interchangeably used as a base or a lid of the container. Accordingly, the terms “shell,” “component,” “shell component,” “base,” “lid,” and the like may be used interchangeably. A shell as described herein is not limited to the inclusion or exclusion of any element, feature, or component unless express description to that effect is provided herein.

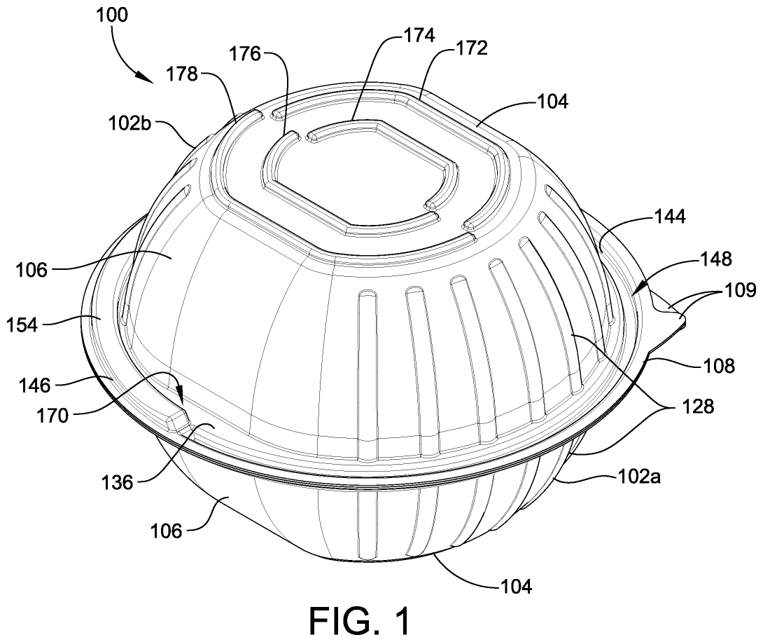

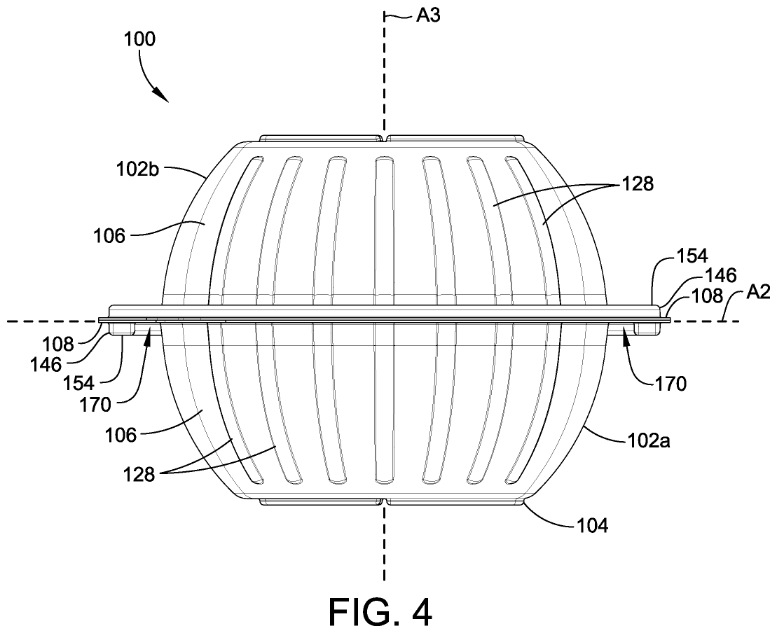

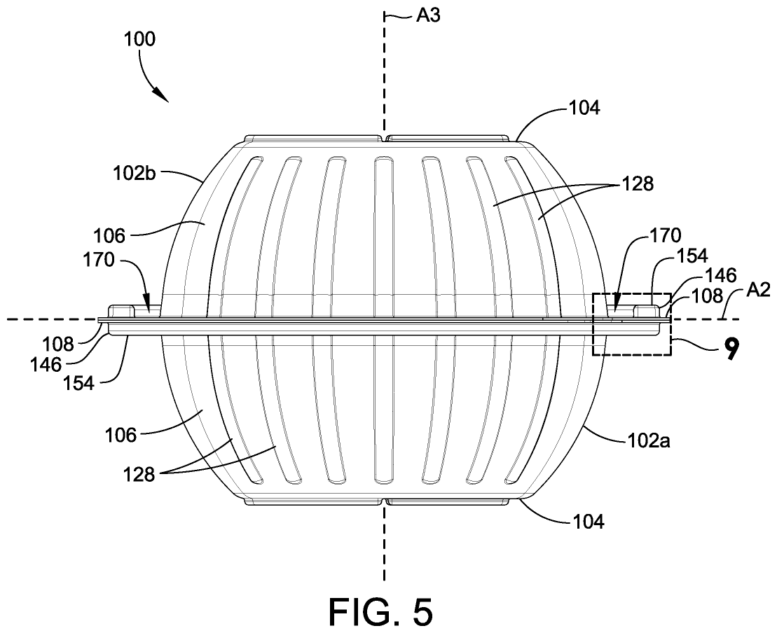

Referring now to the drawings, FIGS. 1-8 depict an example container 100 that is used to transport and/or store contents, such as food items. The container 100 is also used to manually mix the contents therein and enables sufficient mixing of the contents therein while reducing time and/or effort required by a user of the container 100 and reducing a size and footprint required of the container 100 while doing so. In some applications, the container 100 is used to mix multiple food items or ingredients, such as for applying sauce and/or seasoning to chicken wings or mixing salad and dressing. However, it will be appreciated that the container 100 can be used in various mixing applications, and is not limited to mixing food ingredients.

In some embodiments, the container 100 includes similar features and elements as the mixing containers described in U.S. patent application Ser. No. 18/649,731, filed Apr. 29, 2024, titled “CONTAINER FOR MANUALLY MIXING CONTENTS THEREIN,” the disclosure of which is hereby incorporated herein by reference in its entirety.

The container 100 includes a first shell 102a and a second shell 102b. In the orientation shown in FIGS. 1-8, the first shell 102a is located vertically below the second shell 102b. As the description proceeds, the first shell 102a is also referred to as a base 102a of the container 100 and the second shell 102b is also referred to as a lid 102b of the container 100. When the container 100 is in use, and in particular when the container 100 is being used to mix contents therein, the container 100 will assume various orientations as it is manipulated by a user. In this regard, elements and components of the container 100 are described relative to the orientation of the container 100 shown in FIGS. 1-8, but the container 100 is not limited to any particular orientation. As described in more detail below, the first and second shells 102a, 102b have a substantially identical profile and, depending on the orientation of the container 100, such as when the container 100 is flipped or inverted 180 °relative to the illustrated orientation, the first shell 102a can alternatively define the lid of the container 100 and the second shell 102b can alternatively define the base of the container 100.

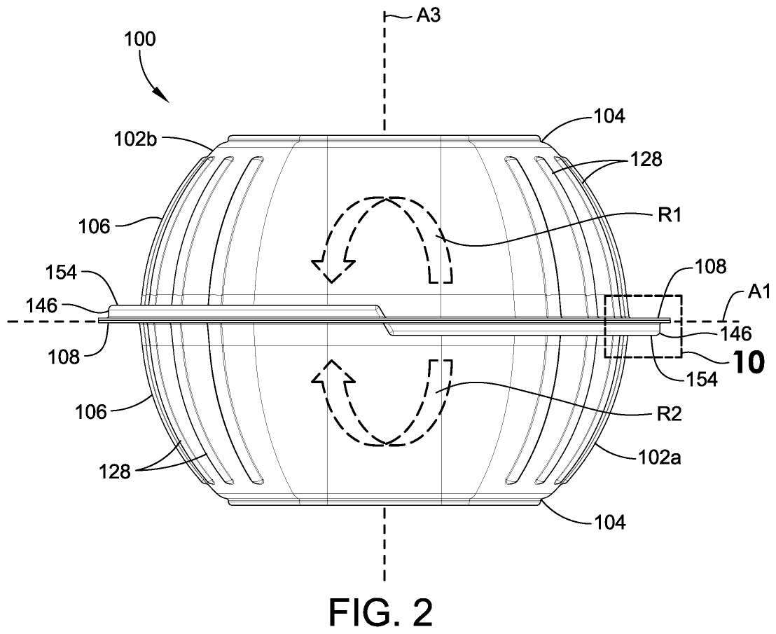

As shown in FIGS. 2-5, the container 100 when formed has a first axis A₁, a second axis A₂ that is perpendicular to the first axis A₁, and a third axis A₃ that is perpendicular to the axes A₁ and A₂. The first axis A₁ is also referred to herein as a first longitudinally horizontal axis A₁. The second axis A₂ is also referred to herein as a second laterally horizontal axis A₂. The third axis A₃ is also referred to herein as a vertical axis A₃. Directional terms used to describe the axes A₁-A₃ and a spatial relation between any of the components herein, including the base 102a and the lid 102b and elements and components of the base 102a and the lid 102b, are used with reference to the orientation of the container 100 and solely for convenience of description. For example, the terms “horizontally,” “vertically,” “outer,” “peripheral,” “outwardly,” “upper,” “inner,” “inwardly,” “upwardly,” “downwardly,” and similar or other directional terms are not limiting with regard to a particular orientation of any component, including the container 100 and the other elements and features described herein.

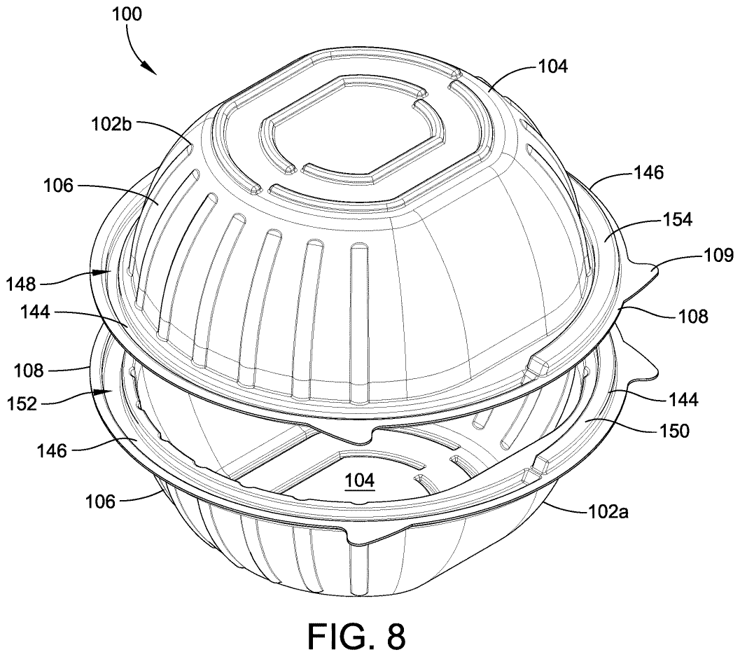

The base 102a and the lid 102b are releasably engageable with each other to selectively provide the container 100 in the closed configuration (FIGS. 1-7), in which the base 102a and the lid 102b are engaged, and an open configuration (FIG. 8), in which the base 102a and the lid 102b are released from each other. Engagement between the base 102a and the lid 102b to close the container 100 will be described below.

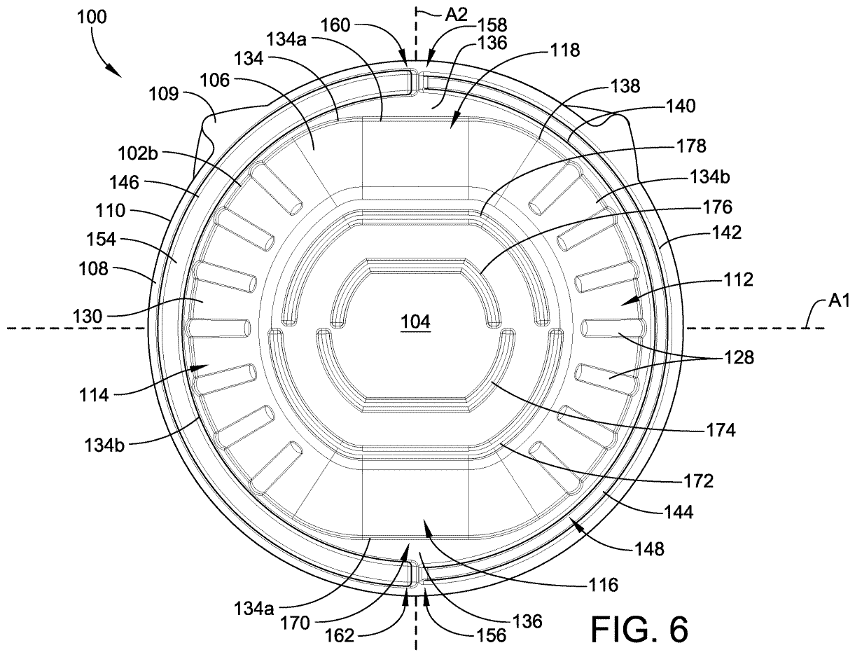

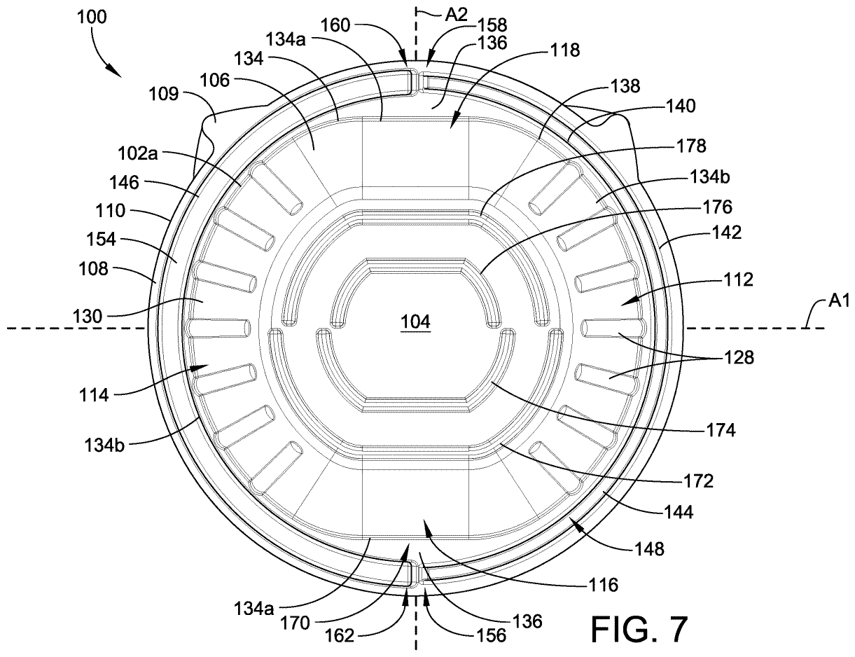

The example container 100 when formed has an oblong or a substantially frusto-ellipsoid and/or round shape that facilitates improving or enhancing mixing of the contents therein. In particular, the body of the container 100, which is defined by sidewalls 106 and cover portions 104 of the base 102a and the lid 102b, has an elliptic or oval shape when viewed in a direction of the vertical axis A₃ (see FIGS. 6 and 7) and is truncated at a bottom of the base 102a and a top of the lid 102b. The rim 108 of the container 100 is circular, corresponding to the circular shape of the rims 108 of the base 102a and lid 102b.

The base 102a and the lid 102b have substantially the same outer profile and overall footprint, and will thus be described as having a substantially identical profile. Express reference herein to an element or component of the base 102a is equally applicable to the lid 102b, and vice versa, unless expressly stated otherwise or the context of the description clearly indicates otherwise. Corresponding reference numerals are used to describe corresponding elements and features that are included in each shell 102a and 102b. Differences may exist between the substantially identically-profiled shells 102a and 102b. Some differences that may exist between the shells 102a and 102b may be described herein.

In some embodiments, the shells 102a, 102b having substantially the same outer profile and overall footprint include similar features to the trays or shells of the containers described in U.S. Publication No. 2024/0025596, published Jan. 25, 2024, titled “CONTAINER FORMED FROM TWO IDENTICAL TRAYS WITH ENGAGEMENT AND DENESTING FEATURES,” and in U.S. Publication No. 2024/0025595, published Jan. 25, 2024, titled “CONTAINER FORMED FROM TWO IDENTICAL TRAYS WITH ENGAGEMENT, VENTING AND STACKING FEATURES,” the disclosures of which are hereby incorporated herein by reference in their entirety. For example, the shells 102a, 102b can include the engagement, denesting, venting, and/or stacking features of the trays or shells described in these publications.

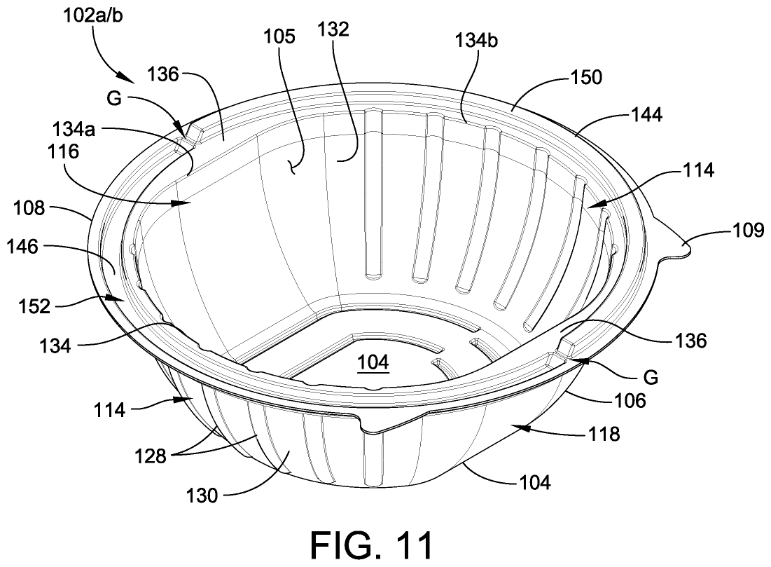

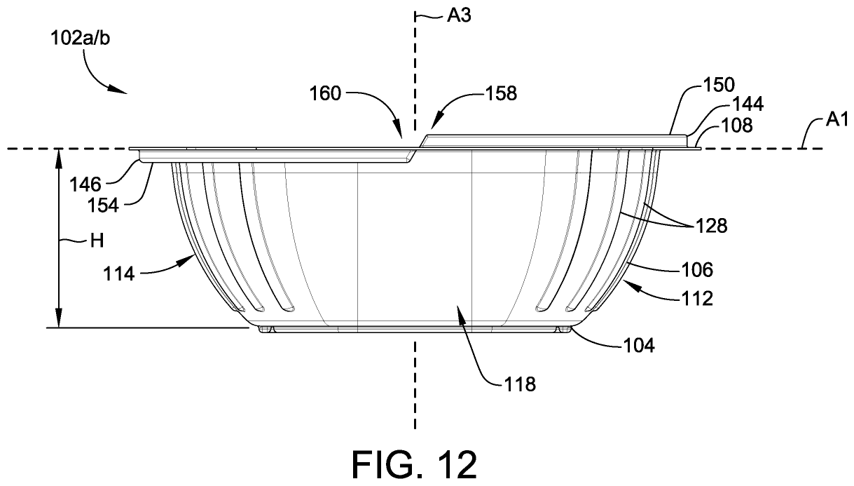

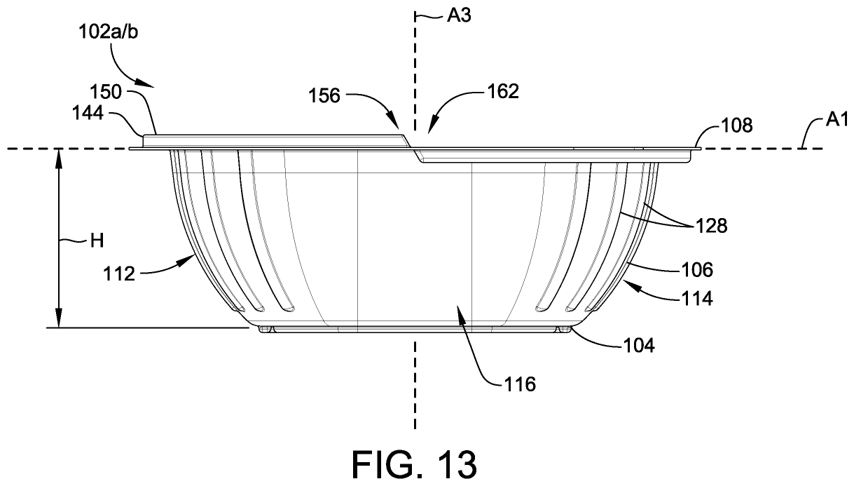

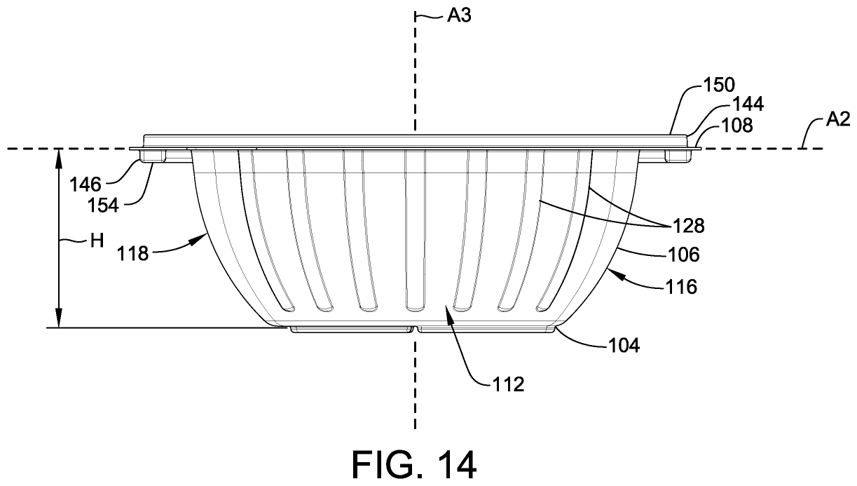

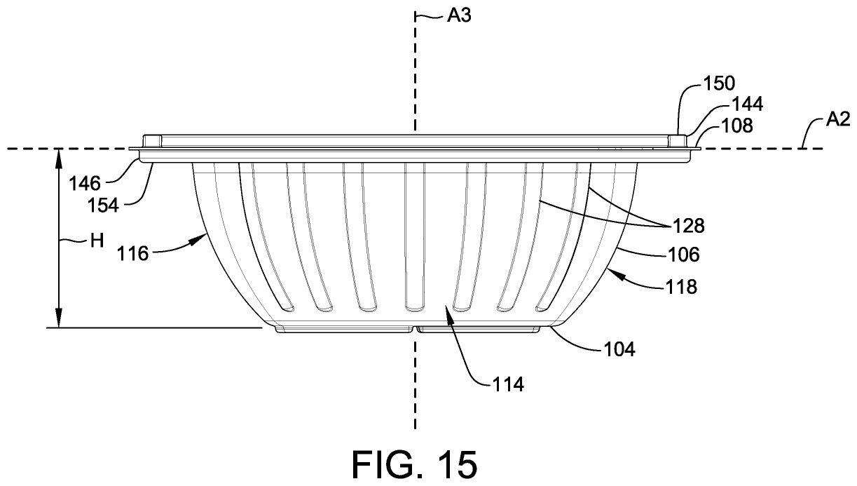

The container 100 shown in FIGS. 1-8 will be described with additional reference to FIGS. 11-17 which depict various isolated views of one of the substantially identically-profiled shells 102a and 102b. For convenience, the first shell 102a and the second shell 102b will be referred to as the shell 102a/b where common features and elements are being described. The shell shown in isolation in FIGS. 11-17 is generally indicated at 102a/b accordingly. The first shell 102a and the second shell 102b will be referred to separately (e.g., as the base 102a and the lid 102b) where reference to the shells 102a, 102b individually is appropriate (e.g., when describing engagement of the shells 102a and 102b to form the container 100). Directional terms used to describe elements of the shell 102a/b are made with reference to the orientation of the shell 102a/b shown in FIGS. 11-17. The shell 102a/b is not limited to any particular orientation.

The shell 102a/b is made of any suitable material. For example, the shell 102a/b may be made of resins or plastic materials including, but not limited to, polyethylene, polypropylene, polyvinyl chloride or polyethylene terephthalate (“PET”). In other embodiments, the shell 102a/b may be made of a fiber based paper substrate. The shell 102a/b may be thermoformed, blow-molded, or injection molded, or may be made using any other suitable technique. The shell 102a/b may be transparent or translucent, and may be colored or dyed in either instance.

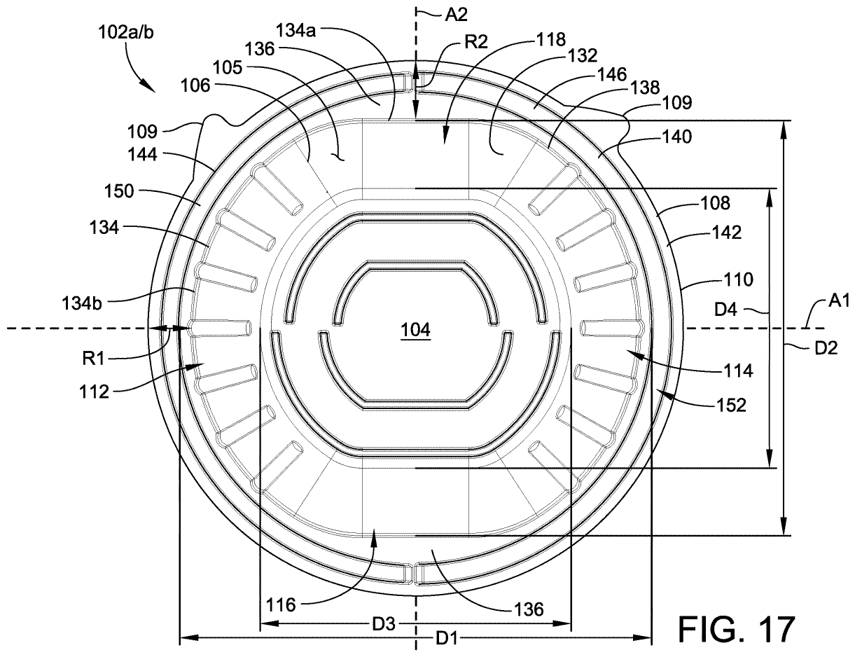

As shown in FIGS. 11-17, the shell 102a/b includes a cover portion 104, a sidewall 106, and a peripheral rim 108. The sidewall 106 extends between and joins the cover portion 104 and the peripheral rim 108. The sidewall 106 and the cover portion 104 define an interior 105 of the shell 102a/b. The peripheral rim 108 extends along a periphery of the shell 102a/b and envelops the interior 105. A shape of the rim 108 and a shape of the sidewall 106 cooperate to define the shape of the shell 102a/b. The sidewall 106 includes two longitudinal ends 112, 114 and two lateral sides 116, 118. The lateral sides 116, 118 of the sidewall 106 are truncated at the rim 108 relative to the longitudinal ends 112, 114. As such, the sidewall 106 defines an elliptic or oval opening (shown in FIG. 17) to the interior 105 of the shell 102a/b . The shape of the shell 102a/b, which, when engaged with another shell 102a/b, defines the container 100 having the circular rim 108 and a substantially an oblong or substantially frusto-ellipsoid and/or round shape body, is described in more detail below.

The cover portion 104 is substantially flat or planar in extent across the sidewall 106 in the illustrated example. The cover portion 104 also includes stacking members 172, 174, 176, and 178 that extend outwardly from an outer surface 107 of the cover portion. The cover portion 104 may be contoured (e.g., dome-shaped) or have other non-planar features (e.g., raised features and/or indented features) in addition to or in the alternative to the stacking member 172-178 in some examples. In the illustrated example, the stacking members 172-178 are each U-shaped stacking bars. The stacking members 172, 178 each extend in a U-shape proximate a peripheral edge of the cover portion 104 adjacent the sidewall 106. The stacking members 174, 176 are respectively located inboard of the stacking members 172, 178 and extend in a U-shape proximate a center of the cover portion 104. The stacking member 172 is offset relative to the stacking member 178 and the stacking member 174 is offset relative to the stacking member 176. As such, when another shell 102a/b is inverted (e.g., rotated 180 °) relative to and stacked on the shell 102a/b, the stacking members 172-178 of the stacked, inverted shells 102a/b are interleaved, and enable stacking the shells 102a/b while limiting or restricting lateral movement of the stacked shells 102a/b relative to one another. One or more of the stacking members 172-178 project inwardly on the interior side of the cover portion 104. The interior projections of the stacking members 172-178 support food products received within the container 100 above at least a portion of a resting volume of sauce and/or seasoning within the container 100. In some embodiments, the stacking members 172-178 include the stacking members described in U.S. Publication No. 2024/0025596 and U.S. Publication No. 2024/0025595, which are incorporated by reference.

In the illustrated example, the sidewall 106 includes structural ribs 128 that extend outwardly from an outer surface 130 of the sidewall 106 and height-wise on the sidewall 106 (relative to the vertical axis A₃). Additionally or alternatively, in some embodiments the structural ribs 128 may extend inwardly from the inner surface 132 of the sidewall 106. The structural ribs 128 provide strength to the sidewall 106, allowing the sidewalls to withstand downwardly applied force (e.g., when closing the container 100). The structural ribs 128 also increase a load capacity of the container 100 such that multiple containers 100 (and/or multiple shells 102a/b) can be stacked on top of one another. The structural ribs 128 can have any suitable shape to enable the ribs 128 to function as described. In some embodiments, the structural ribs 128 are generally V-shaped in outward extent from the sidewall 106, as is described in U.S. patent application Ser. No. 18/649,731, which is incorporated by reference. In alternative embodiments, the structural ribs 128 are generally U-shaped in outward extend from the sidewall 106. The V-shape of the structural ribs 128 causes the ribs 128 to taper to a reduced surface area at a terminal outer point of the ribs. The reduced surface area of the terminal outer points of the ribs 128 provides an additional advantage of reducing or minimizing transfer of heat between the components within the container 100 and the hands of the user when the container 100 is held.

In the illustrated example, the structural ribs 128 are included on the longitudinal ends 112, 114 of the sidewall 106, and are not included on the lateral sides 116, 118 of the sidewall 106. As shown in FIG. 17, the structural ribs 128 define indents in an inner surface 132 of the sidewall 106, corresponding to the outward extend of the structural ribs 128 from the outer surface 130 of the sidewall 106. The indents in the inner surface 132 can hinder or prevent the contents of the container 100 from pooling downward after mixing. The absence of the structural ribs 128 from the lateral sides 116, 118 provides a smooth contour of the inner surface 132 of the sidewall 106 along the lateral sides 116, 118 for better pooling of the contents of the container 100 after mixing. Alternatively, in some examples, the structural ribs 128 are included on the lateral sides 116, 118 of the sidewall 106 and not includes on the longitudinal ends 112, 114. Alternatively, the structural ribs 128 can be included on the longitudinal ends 112, 114 of the sidewall 106 and the lateral sides 116, 118 of the sidewall 106. Alternatively, the structural ribs 128 can be omitted from the sidewall 106.

A height H of the sidewall 106, measured as a distance between the cover portion 104 and the rim 108 in a direction of the vertical axis A₃, defines a depth of the interior 105 of the shell 102a/b. The height H of the sidewall 106, and depth of the shell 102a/b, may vary based on the intended use of the container 100. In the illustrated embodiment, the depth of the shell 102a/b enables contents of the container 100 to reciprocate between the interior 105 of the base 102a and the interior 105 of the lid 102b for mixing. The height H of the sidewall 106 is the same for the base 102a and the lid 102b in the example container 100. In other embodiments, the height H of the sidewall 106 may vary between the first shell 102a and the second shell 102b, such that the first shell 102a and the second shell 102b have different depths.

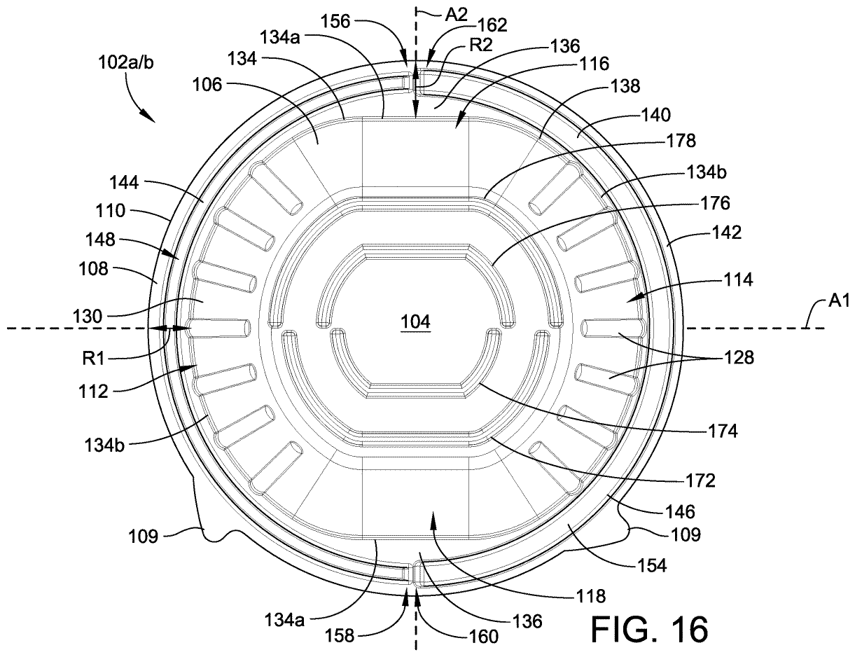

Referring to FIGS. 16 and 17, the rim 108 is circular in shape along its peripheral edge 110. The rim 108 extends between the peripheral edge 110 and the sidewall 106, and meets the sidewall 106 at a junction 134. A radial length of the rim 108 between the peripheral edge 110 and the junction 134 varies because the lateral sides 116, 118 of the sidewall 106 are truncated at the junction 134 relative to the longitudinal ends 112, 114. The junction 134 includes straight segments 134a between the lateral sides 116, 118 of the sidewall 106 and the rim 108, and arcuate segments 134b between the longitudinal ends 112, 114 of the sidewall 106 and the rim 108. The curvature of the arcuate segments 134b of the junction 134 substantially matches the curvature of the peripheral edge 110 of the rim 108, such that a radial length R₁ of the rim 108 is substantially constant between the peripheral edge 110 and arcuate segments 134b of the junction 134 as the rim 108 extends circumferentially. The straight segments 134a of the junction 134 cause the radial length of the rim 108 to increase to a maximum radial length R₂, measured between the junction 134 and the peripheral edge 110 in a direction of the laterally horizontal axis A₂.

The increase in the radial length of the rim 108 to the maximum radial length R₂ provides gripping areas 136 of the rim 108 proximate the lateral sides 116, 118 of the sidewall 106 that can be used as a grip 170 for manipulating the container 100. The gripping areas 136 are formed as an elongate portion of a proximal segment 138 of the rim 108.

The rim 108 includes the proximal segment 138, a bead segment 140, and a distal segment 142. The proximal segment 138 extends outwardly from the junction 134 to the bead segment 140. The bead segment 140 extends outwardly from the proximal segment 138 to the distal segment 142. The distal segment 142 extends outwardly from the bead segment 140 and terminates at the peripheral edge 110 of the rim 108. Collectively, a radial distance extended by the proximal segment 138, the bead segment 140, and the distal segment 142 is approximately equal to the radial length of the rim 108. The extent of the proximal segment 138 increases in radial distance as the radial length of the rim 108 increases from R₁ to R₂, and defines the gripping areas 136 as described above. The bead segment 140 and the distal segment 142 have a substantially constant radial extent along the circumferential extent of the rim 108.

In the illustrated example, the proximal segment 138 and the distal segment 142 are substantially flat or planar. When the container 100 is closed, the rims 108 of the shells 102a and 102b are at least partially in face-to-face contact. For example, the proximal segments 138, the bead segments 140, and/or the distal segments 142 of the shells 102a and 102b are respectively in face-to-face contact when the shells are engaged and the container 100 is closed.

In the example embodiment, the shell 102a/b includes at least one tab 109 extending outwardly from the peripheral edge 110 of the rim 108. In the illustrated example, the shell 102a/b includes two tabs 109. The tabs 109 extend outwardly from the distal segment 142 at locations between the two horizontal axes A₁ and A₂. When the container 100 is formed, each tab 109 of the first shell 102a overlaps a tab 109 of the second shell 102b. The tabs 109 are sized and shaped to enable a user to grasp the tabs 109 and, when the container 100 is formed, to peel the tabs 109 of the shells 102a, 102b apart to open the container 100. Any number of tabs 109 may be included, and the tab(s) 109 may be included at any location along the rim 108.

Referring generally to FIGS. 11-17, the bead segment 140 of the rim 108 of the shell 102a/b facilitates frictional engagement between the first shell 102a and the second shell 102b to releasably seal the container 100 in the closed configuration. The bead segment 140 may facilitate both engagement of the shells 102a, 102b and denesting of stacked shells 102a/b, as is described in U.S. Publication No. 2024/0025596 and U.S. Publication No. 2024/0025595, which are incorporated by reference.

The bead segment 140 includes an upwardly-extending member 144 and a downwardly-extending member 146. The upwardly-extending member 144 defines a first cavity 148 and includes an upper bead 150. The upper bead 150 is spaced above (e.g., raised relative to) the proximal segment 138 and the distal segment 142. The distance that the upper bead 150 is spaced above the proximal segment 138 and the distal segment 142 may be referred to as a height of the upper bead 150. The downwardly-extending member 146 defines a second cavity 152 and includes a lower bead 154. The lower bead 154 is spaced below (e.g., lowered relative to) the proximal segment 138 and the distal segment 142. The distance that the lower bead 154 is spaced below the proximal segment 138 and the distal segment 142 may be referred to as a height of the lower bead 154.

The upwardly-extending member 144 and the downwardly-extending member 146 of the shell 102a/b each extend along the bead segment 140 of the rim 108 to envelop a substantial portion of the proximal segment 138. The upwardly-extending member 144 and the downwardly-extending member 146 may each have a substantially constant dimension or cross-sectional profile along their respective extent. The dimensions and the cross-section profiles of the upwardly-extending member 144 and the downwardly-extending member 146 may be similar to those described for the upwardly-extending members and the downwardly-extending members in U.S. Publication No. 2024/0025596 and U.S. Publication No. 2024/0025595, which are incorporated by reference.

The upwardly-extending member 144 and the downwardly-extending member 146 each extends circumferentially along the rim 108 to envelop a respective portion of the proximal segment 138. In this example, the upwardly extending-member 144 and the downwardly-extending member 146 extend an approximately equal circumferential distance. In other examples, the upwardly-extending member 144 and the downwardly-extending member 146 extend different circumferential distances along the bead segment 140.

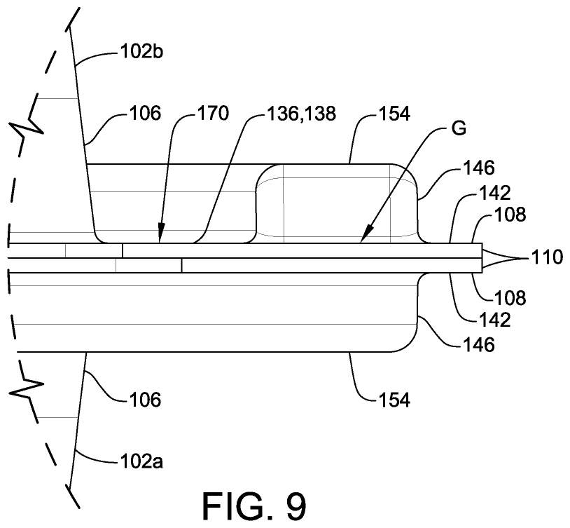

The upwardly-extending member 144 extends between a first end 156 and a second end 158. The downwardly-extending member 146 extends between a first end 160 and a second end 162. The first end 156 of the upwardly-extending member 144 is located proximate the second end 162 of the downwardly-extending member 146, and the second end 158 of the upwardly-extending member 144 is located proximate the first end 160 of the downwardly-extending member 146. The upwardly-extending member 144 and the downwardly-extending member 146 terminate at their respective ends prior to reaching the proximate end of the other member 144, 146, such that a gap G (FIGS. 9 and 11) is defined between the ends 156, 162 and between the ends 158, 160.

The bead segment 140 may be substantially flat or planar at the gaps G between the ends 156, 162 and the ends 158, 160. Alternatively, a vent channel may be defined in the bead segment 140 at one or both of the gaps G between the ends 156, 162 and the ends 158, 160. The vent channels may be formed as described in U.S. Publication No. 2024/0025596, U.S. Publication No. 2024/0025595, and U.S. patent application Ser. No. 18/649,731, which are incorporated by reference. As described therein, the vent channels create narrow paths through the seal between the engaged rims 108 of the shells 102a, 102b when the container is formed to enable venting heat and/or moisture from the container 100 while limiting or preventing leakage of the contents from the container 100. The vent channels may additionally or alternatively be formed in the rim 108 at any suitable location, including any suitable location on the proximal segment 138, the bead segment 140, and/or the distal segment 142 to enable the vent channels to function as described.

In the example shell 102a/b, the gaps G between the ends 156, 162 and the ends 158, 160 are proximate to, or aligned with, the laterally horizontal axis A₂, such that the gaps G are located adjacent the gripping areas 136. When the container 100 is formed and used to mix the contents therein, the gaps G (and, in some instances, the vents extending through the gaps G) create a risk that the contents will leak from the container 100. Locating the gripping areas 136 adjacent the gaps G between the ends 156, 162 and the ends 158, 160 reduces or minimizes the risk of leakage because the user's gripping or pinching force in the gripping areas 136 to manipulate the container 100 acts as a seal outboard of the gaps G.

The distance defined by the gaps G between the ends 156, 162 and the ends 158, 160 may vary depending on the circumferential extent of the upwardly-extending member 144 and the downwardly-extending member 146. In the illustrated example, the upwardly-extending member 144 and the downwardly-extending member 146 each extend circumferentially along approximately half of the circumferential extent of the bead segment 140, forming complementing C-shapes or U-shapes as shown in FIGS. 16 and 17 for example. The gaps G between the ends of the upwardly-extending member 116 and the downwardly-extending member 118 are relatively small in distance in this example. In other examples, the upwardly-extending member 144 and/or the downwardly-extending member 146 may extend a relatively shorter circumferential distance than the illustrated example, such that the gaps G between the ends 156, 162 and/or the ends 158, 160 are relatively larger.

In the illustrated example, the upwardly-extending member 144 extends continuously (e.g., uninterrupted) between the ends 156, 158, and the downwardly-extending member 146 extends continuously (e.g., uninterrupted) between the ends 160, 162. In other examples, the upwardly-extending member 144 and the downwardly-extending member 146 may include discontinuities along their respective circumferential extents. The discontinuities in the upwardly-extending member 144 and the downwardly-extending member 146 may be locations where the respective bead 150, 154 has a relatively taller or shorter height, or the discontinuities may be discrete locations along the bead segment 140 where the upwardly-extending member 144 and the downwardly-extending member 146 temporarily terminate in extent and the bead segment 140 is substantially flat or planar. In examples where such discontinuities exist, the discontinuities in the upwardly-extending member 144 may suitably complement the discontinuities in the downwardly-extending member 146 to enable sealing engagement between the upwardly-extending member 144 and the downwardly-extending member 146.

The sidewall 106 of the shell 102a/b is oblong in shape with a tapered diameter between the rim 108 and the cover portion 104. When the two shells 102a, 102b are inverted relative to one another and engaged to form the container 100, the oblong or substantially frusto-ellipsoid and/or round shape of the container 100 with the circular rim 108 is defined. Additionally, when the container 100 is formed, the two shells 102a, 102b having the substantially identical profiles define a substantially mirror-image relative to planes respectively defined by the horizontal axes A₁ and A₂, the longitudinally horizontal axis A₁ and the vertical axis A₃, and the laterally horizontal axis A₂ and the vertical axis A₃. The interiors 105 of the two shells 102a, 102b cooperatively form a mixing chamber of the closed container 100 for mixing contents therein.

In the illustrated example, the sidewall 106 of the shell 102a/b has a substantially round hemi-ellipsoid shape and is truncated at the cover portion 104. With reference to FIG. 17, the junction 134 and the cover portion 104 each has an elliptic or oval shape. The junction 134 defines the elliptic or oval shaped opening to the interior 105 of the shell 102a/b. The junction 134 has defines two conjugate diameters D₁ and D₂ (FIG. 17). The diameter D₁ is measured between the arcuate segments 134b of the junction 134 in a direction of the longitudinally horizontal axis A₁. The diameter D₂ is measured between the straight segments 134a of the junction 134 in a direction of the laterally horizontal axis A₂.

The elliptic shape of the junction 134, defined by the straight segments 134a and the arcuate segments 134b, is such that a ratio of D₁ to D₂ is greater than 1. The ratio of D₁ to D₂ may be any value greater than 1 that enables the container 100 to function as described herein. In certain examples, the ratio of D₁ to D₂ is greater than 1.05. For example, the ratio of D₁ to D₂ is between about 1 to about 1.8, between about 1.05 to about 1.5, between about 1.05 to about 1.4, between about 1.05 to about 1.3, between about 1.05 to about 1.25, between about 1.05 to about 1.2, between about 1.05 to about 1.15, between about 1.05 to about 1.1, between about 1.1 to about 1.5, between about 1.1 to about 1.4, between about 1.1 to about 1.3, between about 1.1 to about 1.25, between about 1.1 to about 1.2, between about 1.1 to about 1.15, between about 1.15 to about 1.25, between about 1.15 to about 1.2, between about 1.2 to about 1.3, or between about 1.2 to about 1.25. In some embodiments, the ratio of D₁ to D₂ is about 1.05, about 1.1, about 1.15, about 1.2, about 1.25, about 1.3, about 1.35, about 1.4, about 1.45, or about 1.5. In some embodiments, the ratio of D₁ to D₂ is between about 1.05 to about 1.2, or about 1.1.

The sidewall 106 of the shell 102a/b is curved relative to the vertical axis A₃ at the longitudinal ends 112, 114 and at the lateral sides 116, 118. The curvature of the sidewall 106 promotes downward pooling of the contents in the container 100 after mixing in the direction of the vertical axis A₃. The curvature of the sidewall 106 defines a concave shape as the sidewall 106 extends between the rim 108 and the cover portion 104. The cover portion 104 also has an elliptic or oval shape that complements the shape of the junction 134 (i.e., with straight peripheral segments adjacent the lateral sides 116, 118 and arcuate segments adjacent the longitudinal ends 112, 114). The interior 105 of the shell 102a/b has two conjugate diameters D₃ and D₄ proximate the cover portion 104. The diameter D₃, like the diameter D₁, extends in the direction of the longitudinally horizontal axis A₁ and the diameter D₄, like the diameter D₂, extends in the direction of the laterally horizontal axis A₂.

The elliptic shape of the cover portion 104 of the shell 102a/b is such that a ratio of D₃ to D₄ is greater than 1. The ratio of D₃ to D₄ may be any value greater than 1 that enables the container 100 to function as described herein. In certain examples, the ratio of D₃ to D₄ is greater than 1.05, or greater than 1.1. For example, the ratio of D₃ to D₄ is between about 1 to about 1.8, between about 1.05 to about 1.5, between about 1.05 to about 1.4, between about 1.05 to about 1.3, between about 1.05 to about 1.25, between about 1.05 to about 1.2, between about 1.05 to about 1.15, between about 1.05 to about 1.1, between about 1.1 to about 1.5, between about 1.1 to about 1.4, between about 1.1 to about 1.3, between about 1.1 to about 1.25, between about 1.1 to about 1.2, between about 1.1 to about 1.15, between about 1.15 to about 1.25, between about 1.15 to about 1.2, between about 1.2 to about 1.3, or between about 1.2 to about 1.25. In some embodiments, the ratio of D₃ to D₄ is about 1.05, about 1.1, about 1.15, about 1.2, about 1.25, about 1.3, about 1.35, about 1.4, about 1.45, or about 1.5. In some embodiments, the ratio of D₃ to D₄ is between about 1.1 to about 1.25, or between about 1.15 to about 1.2, such as about 1.15 or about 1.2.

The curvature of the sidewall 106 and the shape of the junction 134 and the cover portion 104 is such that the interior 105 is tapered in diameter between the conjugate diameters D₁, D₂ at the junction 134 and the conjugate diameters D₃, D₄ proximate the cover portion 104. That is, the sidewall 106 curves relative to the vertical axis A₃ as the sidewall 106 extends downwardly such that a diameter of the interior 105 measured in the direction of the longitudinally horizontal axis A₁ tapers from the diameter D₁ to the diameter D₃ and a diameter of the base chamber 105 measured in the direction of the laterally horizontal axis A₂ tapers from the diameter D₂ to the diameter D₄. As such, the diameter D₁ is greater than the diameter D₃ and the diameter D₂ is greater than the diameter D₄.

In the illustrated example, the sidewall 106 has a greater degree of curvature, relative to the vertical axis A₃, at the lateral sides 116, 118 than at longitudinal ends 112, 114 of the sidewall 106. The greater degree of curvature of the sidewall 106 at the laterally horizontal sides translates to the ratio of D₁ to D₂ being smaller than the ratio of D₃ to D₄. That is, the sidewall 106 is curved such that the diameter of the interior 105 has a greater taper between the diameters D₂ and D₄ than a taper between the diameters D₁ and D₃. In these examples, the ratio of D₁ to D₂ and the ratio of D₃ to D₄ are each independently greater than 1, with the proviso that the ratio of D₁ to D₂ is smaller than the ratio of D₃ to D₄. For example, the ratio of D₁ to D₂ and the ratio of D₃ to D₄ are independently between about 1.05 to about 1.5, between about 1.05 to about 1.4, between about 1.05 to about 1.3, between about 1.05 to about 1.25, between about 1.05 to about 1.2, between about 1.05 to about 1.15, between about 1.05 to about 1.1, between about 1.1 to about 1.5, between about 1.1 to about 1.4, between about 1.1 to about 1.3, between about 1.1 to about 1.25, between about 1.1 to about 1.2, between about 1.1 to about 1.15, between about 1.15 to about 1.25, between about 1.15 to about 1.2, between about 1.2 to about 1.3, or between about 1.2 to about 1.25, with the proviso that the ratio of D₁ to D₂ is smaller than the ratio of D₃ to D₄. In some embodiments, the ratio of D₁ to D₂ is between about 1.05 to about 1.2 or between about 1.05 to about 1.15, and the ratio of D₃ to D₄ is between about 1.1 to about 1.25 or between about 1.15 to about 1.2, with the proviso that the ratio of D₁ to D₂ is smaller than the ratio of D₃ to D₄. In certain examples, the ratio of D₁ to D₂ is about 1.05 or about 1.1 and the ratio of D₃ to D₄ is about 1.15 or about 1.2.

In other examples, the degree of curvature of the sidewall 106 relative to the vertical axis A₃ may be substantially consistent, such that the ratio of D₁ to D₂ is approximately equal (e.g., within a range of +/−1%) to the ratio of D₃ to D₄. In some such examples, the ratio of D₁ to D₂ and the ratio of D₃ to D₄ are approximately equal and are each greater than 1, or greater than 1.05. In various examples, the ratio of D₁ to D₂ and the ratio of D₃ to D₄ are approximately equal and are each between about 1 to about 1.8, between about 1.05 to about 1.5, between about 1.05 to about 1.4, between about 1.05 to about 1.3, between about 1.05 to about 1.25, between about 1.05 to about 1.2, between about 1.05 to about 1.15, between about 1.05 to about 1.1, between about 1.1 to about 1.5, between about 1.1 to about 1.4, between about 1.1 to about 1.3, between about 1.1 to about 1.25, between about 1.1 to about 1.2, between about 1.1 to about 1.15, between about 1.15 to about 1.25, between about 1.15 to about 1.2, between about 1.2 to about 1.3, or between about 1.2 to about 1.25. In some embodiments, the ratio of D₁ to D₂ and the ratio of D₃ to D₄ are approximately equal and are each about 1.05, about 1.1, about 1.15, about 1.2, about 1.25, about 1.3, about 1.35, about 1.4, about 1.45, or about 1.5.

The sidewall 106 may have any suitable curvature to enable the container 100 to function as described herein. For example, the sidewall 106 may have any suitable curvature such that ratio of D₁ to D₂ and the ratio of D₃ to D₄ are each independently greater than 1, or greater than 1.05, such as between about 1 to about 1.8, between about 1.05 to about 1.5, between about 1.05 to about 1.4, between about 1.05 to about 1.3, between about 1.05 to about 1.2, between about 1.05 to about 1.15, between about 1.05 to about 1.1, between about 1.1 to about 1.5, between about 1.1 to about 1.4, between about 1.1 to about 1.3, between about 1.1 to about 1.25, between about 1.1 to about 1.2, between about 1.1 to about 1.15, between about 1.15 to about 1.25, between about 1.15 to about 1.2, between about 1.2 to about 1.3, or between about 1.2 to about 1.25.

As described above, the sidewall extends the height H between the cover portion 104 and the rim 108. The height H translates to a depth of the shell 102a/b. The height H is any suitable height that enables the container 100 to function as described. In particular, the height H suitably translates to a sufficient depth of the shell 102a/b to enable the contents of the container 100 to be contained therein. The height H of the shells 102a, 102b also enables the contents of the container 100 to reciprocate between the interiors 105 of the shells 102a/b during mixing. In the example container, the height H is such that a ratio of H to D₂ is between about 0.3 to about 0.7, such as between about 0.3 to about 0.6, between about 0.3 to about 0.55, between about 0.3 to about 0.5, between about 0.3 to about 0.4, between about 0.3 to about 0.35, between about 0.35 to about 0.45, between about 0.35 to about 0.4, between about 0.4 to about 0.5, between about 0.4 to about 0.45, or between about 0.45 to about 0.5. The ratio of H to D₂ may be such that the container 100 is enabled to function as described herein, and also such that an overall size and footprint of the container 100 and/or the shell 102a/b is limited. That is, the ratio of H to D₂ may be any suitable ratio to enable the container 100 to function as described herein while also limiting size and footprint of the container 100 and/or shell 102a/b for improved usability (e.g., easier and more convenient handling, transporting, and storing).

Referring generally to FIGS. 1-17, the container 100 is formed by the two shells 102a, 102b with the second shell 102b inverted (e.g., rotated 180 °) relative to the first shell 102a to enable engagement between the rims 108 of the shells 102a and 102b. In the illustrated orientation, as described above, the second shell 102b is vertically above the first shell 102a, with the second shell 102b defining the lid of the container 100 and the first shell 102a defining the base on the container 100.

The lid 102b and the base 102a engage one another to close the container 100 (FIGS. 1-7). The rims 108, and in particular the bead segments 140, of the lid 102b and the base 102a facilitate the engagement. The second cavity 152 and the upwardly-extending member 144 of each shell 102a, 102b are suitably sized and shaped such that, when the base 102a engages the inverted lid 102b, the upwardly-extending member 144 of the base 102a is received in the second cavity 152 of the lid 102b, and the upwardly-extending member 144 of the lid 102b is received in the second cavity 152 of the base 102a. When the base 102a engages the inverted lid 102b, the upwardly-extending member 144 of the base 102a engages the downwardly-extending member 146 of the lid 102b in the second cavity 152 by friction, and the upwardly extending member 144 of the lid 102b engages the downwardly-extending member 146 of the base 102a in the second cavity 152 by friction. The frictional engagement between the upwardly-extending members 144 and the downwardly-extending members 146 of the base 102a and the lid 102b when engaged is suitably sufficient to maintain the container 100 in the closed configuration, while enabling the base 102a and the lid 102b to be released from each other to open the container 100 when desired by application of an external force (e.g., a pulling force) on one or both of the base 102a and the lid 102b.

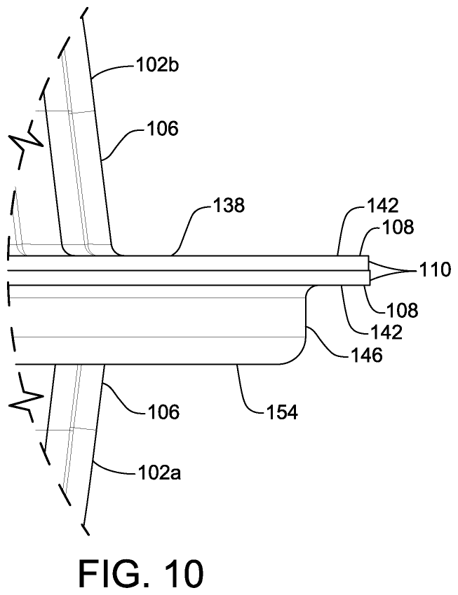

FIGS. 9 and 10 depict engagement between the rims 108 of the base 102a and the lid 102b in greater detail, which creates a peripheral seal of the closed container 100. The upwardly-extending members 144 are respectively received in the second cavities 152 of the downwardly-extending members 146. The proximal segments 138 and the distal segments 142 of the rims 108 are also in face-to-face contact to create a more reliable seal. In the illustrated example, the peripheral edges 110 of the rims 108 are flush with one another.

In some embodiments, the upwardly-extending member 144 and the downwardly-extending member 146 engage one another to close the container 100 as described in in U.S. Publication No. 2024/0025596 and U.S. Publication No. 2024/0025595, which are incorporated by reference. Additionally, as is described in these publications, the upwardly-extending member 144 and the downwardly-extending member 146 may facilitate denesting of stacked shells 102a/b.

When the container 100 is closed, the interiors 105 of the base 102a and the lid 102b define a mixing chamber of the container 100 that is sized and shaped to enable mixing of the contents of the container. Suitably, as described above, the height H of the base 102a and the lid 102b enable the contents to reciprocate within the mixing chamber of the container 100 between the interiors 105 to achieve sufficient mixing.

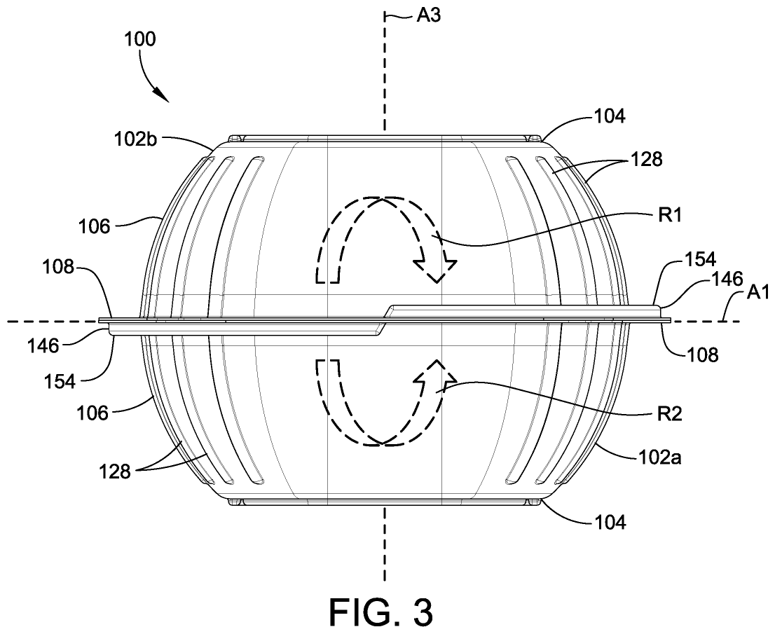

In a manual mixing operation using the container 100, the closed container 100 with the contents stored therein is rotated by a user using the grips 170 about the laterally horizontal axis A₂. Rotation of the container 100 about the axis A₂ may reciprocate between a forward rotational direction R₁ and a backward rotational direction R₂ (shown in FIGS. 2 and 3).

The container 100 is dimensioned to facilitate mixing the contents in the mixing chamber using this rotational movement. This facilitates improving the manual mixing operation, avoiding excessive time and/or effort and awkward movement to mix the contents, and ensures a consistent and repeatable manual mixing method using the container 100. For example, as described above, the mixing chamber of the container 100 is sized such that, during rotation of the container 100 about the laterally horizontal axis A₂, the contents reciprocate between the interiors of the base 102a and the lid 102b. The contents remain centered relative to a plane defined by the longitudinally horizontal axis A₁ and the vertical axis A₃ due to the ratio of the conjugate diameters D₁ and D₂ and D₃ and D₄. That is, radially outward movement of the contents in the mixing chamber, relative to the plane defined by the axes A₁ and A₃, is limited by the smaller of the two of each pair of conjugate diameters, that is, by the diameters D₂ and D₄. Concurrently, reciprocating movement of the contents between the interiors 105 of the base 102a and the lid 102b is enabled by the heights H as the container 100 is rotated about the laterally horizontal axis A₂. As a result, enhanced mixing of the contents is achieved without the user having to shake the container, or rotate the container about axes other than the laterally horizontal axis A₂. Additionally, after mixing, the curvature profiles of the sidewall 106 promote downward pooling of the contents in the direction of the vertical axis A₃, as well as the smooth contour of the inner surface 132 of the sidewalls 106 along the lateral sides 116, 118.

Mixing and pooling is further promoted by the shape of the junctions 134, and, in particular, the straight segments 134a and the arcuate segments 134b. These segments 134a, 134b define the conjugate diameters D₁ and D₂ that facilitate mixing and centering the contents as described above. Additionally, the immediate (or smooth) transition between the straight segments 134a and the arcuate segments 134b is such that little to no dead space exists within the mixing chamber of the container 100. As a result, the volume of the mixing chamber in which active mixing takes place during rotation of the container 100 is maximized, which enables the size and footprint of the container 100 to be reduced while still achieving sufficient mixing. Additionally, the absence of dead space in the mixing chamber limits or prevents the tendency for some contents to become trapped and promotes downward pooling of all the contents.

When the user grasps the grips 170 for rotating the container 100, the user applies a gripping or pinching force on the gripping areas 136 of the base 102a and the lid 102b. As discussed above, the gripping areas 136 are located adjacent the gaps G between the ends 156, 162 and 158, 160 that create a risk that the contents will leak from the container 100 (e.g., during rotation and mixing). The gripping or pinching force applied at the grips 170 creates a reliable seal inboard of the gaps G (and, in some instances, vent channels formed in the gaps G) and reduces or minimizes the risk of leakage of the contents at these locations through the engaged rims 108 of the base 102a and the lid 102b.

Referring generally to FIGS. 1-17, a method of using the container 100, and in particular a method of mixing contents in the mixing chamber using the container 100, includes placing contents within the interiors 105 of the base 102a and lid 102b when the container 100 is open and then forming or closing the container 100 by engaging the rims 108 to enclose the contents. The rims 108 of the base 102a and the lid 102b engage as described above to form the peripheral seal of the closed container 100.

The method also includes manually mixing the contents in the mixing chamber by rotating the container 100 about the laterally horizontal axis A₂, and in particular by reciprocating rotation of the container 100 about the axis A₂ between the forward rotational direction R₁ and the backward rotational direction R₂ (shown in FIGS. 2 and 3). Suitably, the user rotates the container 100 about the laterally horizontal axis A₂ using the grips 170 of the container 100. During rotation of the container 100 about the axis A₂, the contents reciprocate between the interiors 105 of the base 102a and the lid 102b. The reciprocating movement of the contents between the interiors 105 is enabled by the heights H of the base 102a and the lid 102b, which respectively define a depth of the interiors 105. The contents are centered during rotation of the container 100 about the axis A₂ relative to the plane defined by the axes A₁ and A₃. The centering of the contents about this plane is enabled by the ratios of the ratio of the conjugate diameters D₁ and D₂ and D₃ and D₄ as described above. The centering of the contents and the reciprocating movement thereof results in enhanced mixing of the contents without the user having to shake the container, or rotate the container about axes other than the laterally horizontal axis A₂. After mixing, the curvature profiles of the sidewalls 106 and the smooth contour of the inner surface 132 of the sidewalls 106 along the lateral sides 116, 118 promotes downward pooling of the contents in the direction of the vertical axis A₃.

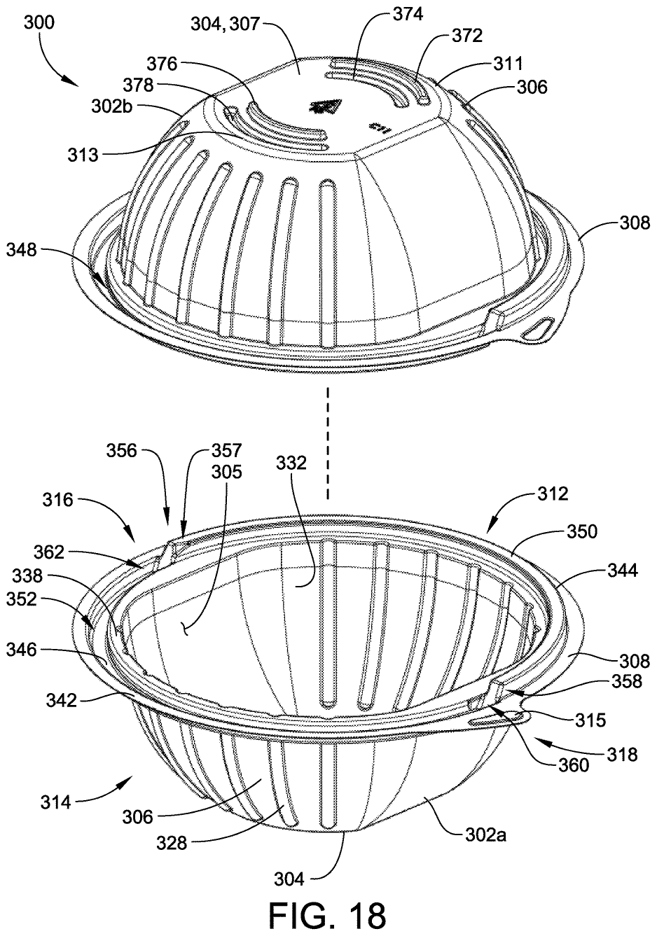

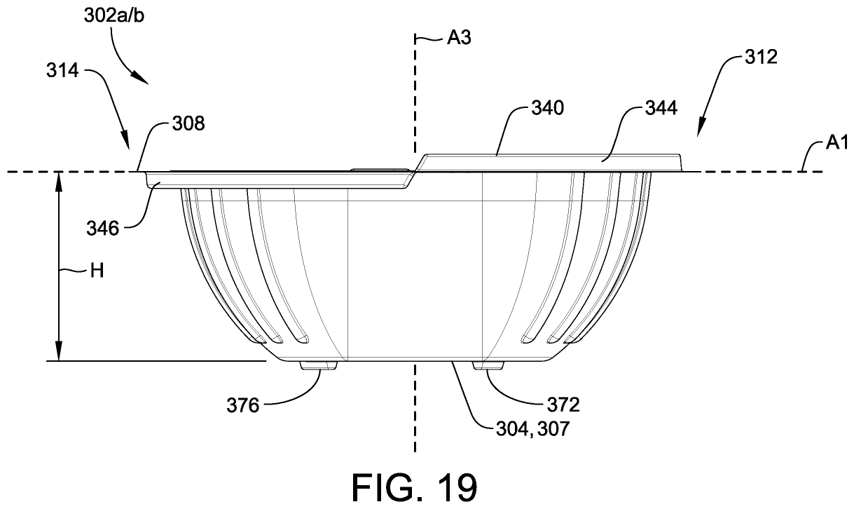

FIG. 18 depicts an exploded view of an alternative container 300 that is used to transport and/or store contents, such as food items. FIGS. 19-21 depict various isolated views of one of the substantially identically-profiled shells 302a and 302b that form the container 300. The container 300 and shells 302a, 302b are substantially the same as the container 100 and shells 102a, 102b shown in FIGS. 1-17, except as described differently herein. Like reference numerals are used for similar components in containers 100 and 300. In particular, among the differences described herein with container 100, the container 300 includes alternative stacking members 372, 374, 376, 378 and an alternative bead segment 340 defining a cut-away section 357.

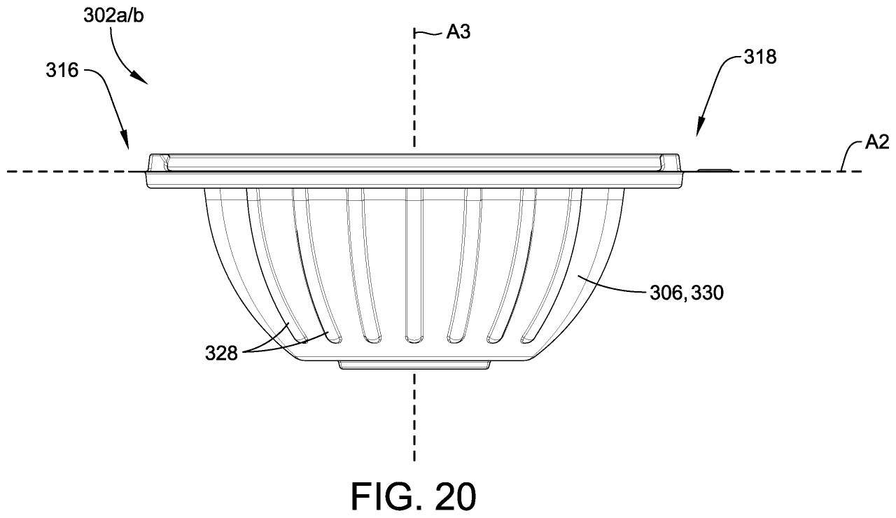

As shown in FIGS. 19 and 20, the container 300 when formed, and the shells 302a, 302b when unformed, have a first longitudinally horizontal axisA₁, a second laterally horizontal axis A₂ that is perpendicular to the first axis A₁, and a third vertical axis A₃ that is perpendicular to the axes A₁ and A₂. The base 302a and the lid 302b are releasably engageable with each other to selectively provide the container 300 in a closed configuration in which the base 302a and the lid 302b are engaged (e.g., similar to the closed configuration of container 100 shown in FIGS. 3-7). In the open configuration (FIG. 18) the base 302a and the lid 302b are released from each other.

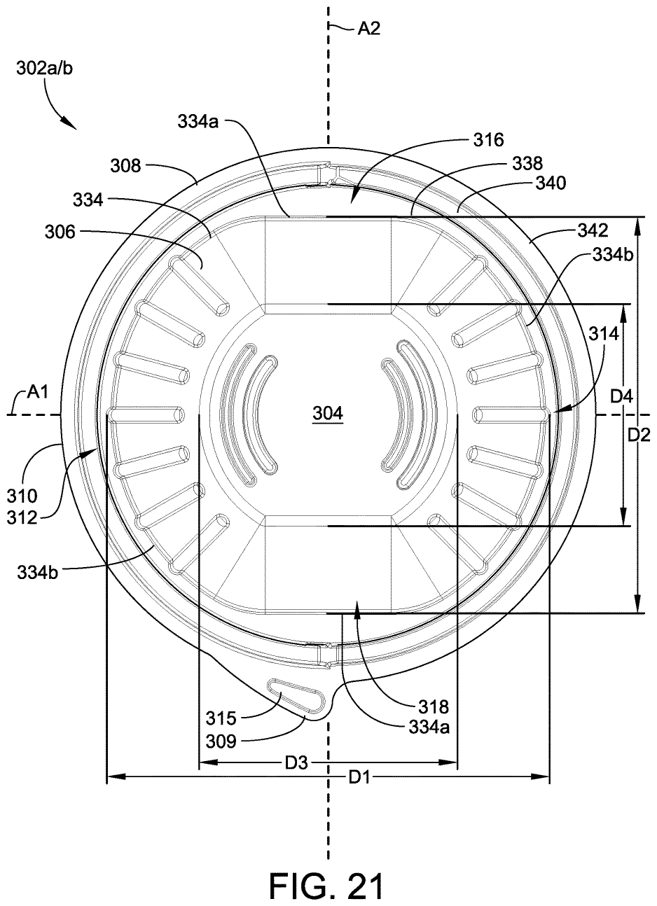

The example container 300 when formed has an oblong or a substantially round frusto-ellipsoid shape that facilitates improving or enhancing mixing of the contents therein. In particular, the body of the container 300, which is defined by sidewalls 306 and cover portions 304 of the base 302a and the lid 302b, has an elliptic or oval shape when viewed in a direction of the vertical axis A₃ (see FIG. 21) and is truncated at a bottom of the base 302a and a top of the lid 302b. The rim 308 of the container 300 is circular, corresponding to the circular shape of the rims 308 of the base 302a and lid 302b. The base 302a and the lid 302b have substantially the same outer profile and overall footprint, and will thus be described as having a substantially identical profile.

The shell 302a/b is made of any suitable material. For example, the shell 302a/b may be made of resins or plastic materials including, but not limited to, polyethylene, polypropylene, polyvinyl chloride or polyethylene terephthalate (“PET”). The shell 302a/b may be thermoformed, blow-molded, or injection molded, or may be made using any other suitable technique. The shell 302a/b may be transparent or translucent, and may be colored or dyed in either instance.

As shown in FIGS. 18-21, the shell 302a/b includes a cover portion 304, a sidewall 306, and a peripheral rim 308. The sidewall 306 extends between and joins the cover portion 304 and the peripheral rim 308. The sidewall 306 and the cover portion 304 define an interior 305 of the shell 302a/b. The peripheral rim 308 extends along a periphery of the shell 302a/b and envelops the interior 305. A shape of the rim 308 and a shape of the sidewall 306 cooperate to define the shape of the shell 302a/b. The sidewall 306 includes two longitudinal ends 312, 314 and two lateral sides 316, 318. The lateral sides 316, 318 of the sidewall 306 are truncated at the rim 308 relative to the longitudinal ends 312, 314. As such, the sidewall 306 defines an elliptic or oval opening (shown in FIG. 21) to the interior 305 of the shell 302a/b . The shape of the shell 302a/b, which, when engaged with another shell 302a/b, defines the container 300 having the circular rim 308 and a substantially an oblong or substantially round frusto-ellipsoid shape body.

The cover portion 304 includes a substantially flat or planar top surface 307 extending across the sidewall 306. The cover portion 304 also includes stacking members 372, 374, 376, and 378 that are positioned on the top surface and either extend outwardly from the top surface 307 or are recessed inwardly of the top surface 307. The stacking members 372, 374, 376, and 378 each have a curved arched shape. In other embodiments, one or more of the stacking members 372, 374, 376, and 378 may have angled shape, such as the U-shaped stacking bars 172, 174, 176, and 178 (shown in FIG. 1). The cover portion 304 may be contoured (e.g., dome-shaped) or have other non-planar features (e.g., raised features and/or indented features) in addition to or in the alternative to the stacking member 372-378 in some examples.

In the illustrated example, the stacking members 372, 378 are each positioned proximate a peripheral edge of the cover portion 304 adjacent the sidewall 306 and extend along an arc corresponding to a curvature of the sidewall 306 about the vertical axis A₃. In particular, in the illustrated example, the stacking members 372, 378 extend in parallel to curved distal edges 311, 313 of the cover portion 304, respectively. The stacking members 374, 376 are respectively located inboard (i.e., radially inward) of the stacking members 372, 378 and extend in an arc parallel to the stacking members 372, 378 and distal edges 311, 313. The stacking members 372, 378 are each arranged symmetrically and are positioned equidistant from a center of the cover portion. The stacking members 374, 376 are each arranged symmetrically and are positioned equidistant from the center of the cover portion.

In the illustrated example, the stacking members 372, 376 each project outwardly from the cover portion 304 and the stacking members 374, 378 are each recessed inwardly on the cover portion 104 and extend into the interior 105. As such, when another shell 302a/b is inverted (e.g., rotated 180 °) relative to and stacked on the shell 302a/b, the stacking members 372 and 378 are aligned such that the projection of the stacking member 372 may be received within the recess defined by the stacking member 378. Likewise, the projection of the stacking member 376 may be received within the recess of the stacking member 374. The stacking members 372-378 thereby provide interlocking engagement between the stacked shells 302a/b , limiting or restricting lateral movement of the stacked shells 302a/b relative to one another. As shown in FIG. 19, the stacking members 372, 376 project downward from the surface 307 and provide feet for supporting the container 300 on an external surface, such as a table.

In the illustrated example, the sidewall 306 includes structural ribs 328 that extend outwardly, and/or inwardly, from an outer surface 330 of the sidewall 306 and height-wise on the sidewall 306 (relative to the vertical axis A₃). In the illustrated example, the structural ribs 328 are included on the longitudinal ends 312, 314 of the sidewall 306, and are not included on the lateral sides 316, 318 of the sidewall 306. As shown in FIG. 18, the structural ribs 328 define indents in an inner surface 332 of the sidewall 306, corresponding to the outward extend of the structural ribs 328 from the outer surface 330 of the sidewall 306. The indents in the inner surface 332 can hinder or prevent the contents of the container 300 from pooling downward after mixing. The absence of the structural ribs 328 from the lateral sides 316, 318 provides a smooth contour of the inner surface 332 of the sidewall 306 along the lateral sides 316, 318 for better pooling of the contents of the container 300 after mixing. Alternatively, in some examples, the structural ribs 328 are included on the lateral sides 316, 318 of the sidewall 306 and not includes on the longitudinal ends 312, 314. Alternatively, the structural ribs 328 can be included on the longitudinal ends 312, 314 of the sidewall 306 and the lateral sides 316, 318 of the sidewall 306. Alternatively, the structural ribs 328 can be omitted from the sidewall 306.

A height H of the sidewall 306, measured as a distance between the cover portion 304 and the rim 308 in a direction of the vertical axis A₃, defines a depth of the interior 305 of the shell 302a/b. The height H of the sidewall 306, and depth of the shell 302a/b, may vary based on the intended use of the container 300. In the illustrated embodiment, the depth of the shell 302a/b enables contents of the container 300 to reciprocate between the interior 305 of the base 302a and the interior 305 of the lid 302b for mixing. The height H of the sidewall 306 is the same for the base 302a and the lid 302b in the example container 300. In other embodiments, the height H of the sidewall 306 may vary between the first shell 302a and the second shell 302b, such that the first shell 302a and the second shell 302b have different depths.

Referring to FIG. 21, the rim 308 is generally circular in shape along its peripheral edge 310. The rim 308 extends between the peripheral edge 310 and the sidewall 306, and meets the sidewall 306 at a junction 334. A radial length of the rim 308 between the peripheral edge 310 and the junction 334 varies because the lateral sides 316, 318 of the sidewall 306 are truncated at the junction 334 relative to the longitudinal ends 312, 314. The junction 334 includes straight segments 334a between the lateral sides 316, 318 of the sidewall 306 and the rim 308, and arcuate segments 334b between the longitudinal ends 312, 314 of the sidewall 306 and the rim 308. The curvature of the arcuate segments 334b of the junction 334 substantially matches the curvature of the peripheral edge 310 of the rim 308, such that a radial length of the rim 308 is substantially constant between the peripheral edge 310 and arcuate segments 334b of the junction 334 as the rim 308 extends circumferentially. The straight segments 334a of the junction 334 cause the radial length of the rim 308 to increase to a maximum radial length, measured between the junction 334 and the peripheral edge 310 in a direction of the laterally horizontal axis A₂.

The rim 308 includes the proximal segment 338, a bead segment 340, and a distal segment 342. The proximal segment 338 extends outwardly from the junction 334 to the bead segment 340. The bead segment 340 extends outwardly from the proximal segment 338 to the distal segment 342. The distal segment 342 extends outwardly from the bead segment 340 and terminates at the peripheral edge 310 of the rim 308. Collectively, a radial distance extended by the proximal segment 338, the bead segment 340, and the distal segment 342 is approximately equal to the radial length of the rim 308. The extent of the proximal segment 338 increases in radial distance as the radial length of the rim 308 increases from R₃ to R₂. The bead segment 340 and the distal segment 342 have a substantially constant radial extent along the circumferential extent of the rim 308. In the illustrated example, the proximal segment 338 and the distal segment 342 are substantially flat or planar. When the container 300 is closed, the rims 308 of the shells 302a and 302b are at least partially in face-to-face contact. For example, the proximal segments 338, the bead segments 340, and/or the distal segments 342 of the shells 302a and 302b are respectively in face-to-face contact when the shells are engaged and the container 300 is closed.

In the example embodiment, the shell 302a/b includes a single tab 309 extending radially outwardly from the peripheral edge 310 of the rim 308, though in other embodiments, the shell 302a/b may include two, three, or any suitable number of tabs 309. The tab 309 includes a projection 315 extending outwardly in the direction of the vertical axis A₃ away from the cover portion 304, such that the projection 315 extends toward the other of shell 302a/302b, when the container 300 is formed. When the container 300 is formed, the tab 309 of the first shell 302a overlaps a tab 309 of the second shell 302b and the projections are oriented in a mirrored orientation relative to one another, as shown in FIG. 18. The tabs 309 are sized and shaped to enable a user to grasp the tabs 309, when the container 300 is formed, to peel the tabs 309 of the shells 302a, 302b apart to open the container 300. The projections 315 provide an interference between the rims 308 of the shells 302a, 302b such that an opening is defined to provide a grip for a user to separate the shells 302a, 302b. Any number of tabs 309 may be included, and the tab(s) 309 may be included at any location along the rim 308.

The bead segment 340 includes an upwardly-extending member 344 and a downwardly-extending member 346. The upwardly-extending member 344 defines a first cavity 348 and includes an upper bead 350. The upper bead 350 is spaced above (e.g., raised relative to) the proximal segment 338 and the distal segment 342. The distance that the upper bead 350 is spaced above the proximal segment 338 and the distal segment 342 may be referred to as a height of the upper bead 350. The downwardly-extending member 346 defines a second cavity 352 and includes a lower bead 354. The lower bead 354 is spaced below (e.g., lowered relative to) the proximal segment 338 and the distal segment 342. The distance that the lower bead 354 is spaced below the proximal segment 338 and the distal segment 342 may be referred to as a height of the lower bead 354.

The upwardly-extending member 344 and the downwardly-extending member 346 of the shell 302a/b each extend along the bead segment 340 of the rim 308 to envelop a substantial portion of the proximal segment 338. The upwardly-extending member 344 and the downwardly-extending member 346 may each have a substantially constant dimension or cross-sectional profile along their respective extent.

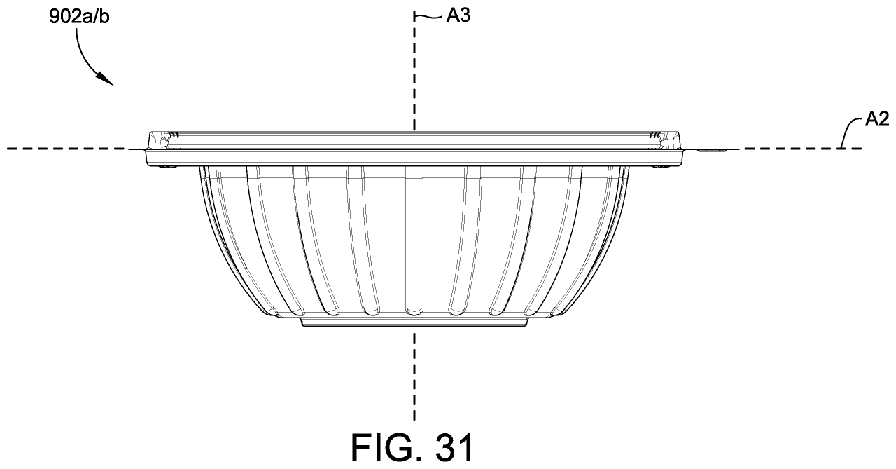

In the example embodiment, the upwardly-extending member 344 extends between a first end 356 and a second end 358. The downwardly-extending member 346 extends between a first end 360 and a second end 362. The first end 356 of the upwardly-extending member 344 is located proximate the second end 362 of the downwardly-extending member 346, and the second end 358 of the upwardly-extending member 344 is located proximate the first end 360 of the downwardly-extending member 346. The upwardly-extending member 344 and the downwardly-extending member 346 terminate at their respective ends prior to reaching the proximate end of the other member 344, 346. In the example embodiment, the second end of the downwardly-extending member 346 is oriented obliquely relative to the first end 356 of the upwardly extending member 344. In the example embodiment, the first end 356 of the upwardly-extending member 344 includes a cut-away section 357 on an internal facing side of the upwardly extending member 344. When the container 300 is assembled a gap (similar to gap G shown in FIGS. 9 and 31) is defined between the ends 356, 362 and defined at least in part by the cut-away sections 357 of the corresponding upwardly extending members 344.

In the example embodiment, the second end 358 of the upwardly-extending member 344 and the first end 360 of the downwardly extending member 346 are oriented at a substantially constant angle, such that a gap is not defined between the ends 358, 360, though in other embodiments the ends 358, 360 may be oriented in substantially the same manner as the ends 356, 362 and/or include a cut-away section, similar to cut-away section 357.

The sidewall 306 of the shell 302a/b is oblong in shape with a tapered diameter between the rim 308 and the cover portion 304. When the two shells 302a, 302b are inverted relative to one another and engaged to form the container 300, the oblong or substantially round frusto-ellipsoid shape of the container 300 with the circular rim 308 is defined. Additionally, when the container 300 is formed, the two shells 302a, 302b having the substantially identical profiles define a substantially mirror-image relative to planes respectively defined by the horizontal axes A₃ and A₂, the longitudinally horizontal axis A₃ and the vertical axis A₃, and the laterally horizontal axis A₂ and the vertical axis A₃. The interiors 305 of the two shells 302a, 302b cooperatively form a mixing chamber of the closed container 300 for mixing contents therein.

In the illustrated example, the sidewall 306 of the shell 302a/b has a substantially round hemi-ellipsoid shape and is truncated at the cover portion 304. With reference to FIG. 21, the junction 334 and the cover portion 304 each has an elliptic or oval shape. The junction 334 defines the elliptic or oval shaped opening to the interior 305 of the shell 302a/b. The junction 334 has defines two conjugate diameters D₁ and D₂. The diameter D₁ is measured between the arcuate segments 334b of the junction 334 in a direction of the longitudinally horizontal axis A₁. The diameter D₂ is measured between the straight segments 334a of the junction 334 in a direction of the laterally horizontal axis A₂.

The sidewall 306 of the shell 302a/b is curved relative to the vertical axis A₃ at the longitudinal ends 312, 314 and at the lateral sides 316, 318. The curvature of the sidewall 306 promotes downward pooling of the contents in the container 300 after mixing in the direction of the vertical axis A₃. The curvature of the sidewall 306 defines a concave shape as the sidewall 306 extends between the rim 308 and the cover portion 304. The cover portion 304 also has an elliptic or oval shape that complements the shape of the junction 334 (i.e., with straight peripheral segments adjacent the lateral sides 316, 318 and arcuate segments adjacent the longitudinal ends 312, 314). The interior 305 of the shell 302a/b has two conjugate diameters D₃ and D₄ proximate the cover portion 304. The diameter D₃, like the diameter D₁, extends in the direction of the longitudinally horizontal axis A₁ and the diameter D₄, like the diameter D₂, extends in the direction of the laterally horizontal axis A₂.

The elliptic shape of the junction 334, defined by the straight segments 334a and the arcuate segments 334b, is such that a ratio of D₁ to D₂ is greater than 1. The shell 302a/b is similarly proportioned to the shell 102a/b (FIG. 17) such that the ratio of D₁ to D₂ and the ratio of D₃ to D₄ for the shell 302a/b may be substantially similar to the shell 102a/b and each may be any value greater than 1 that enables the container 300 to function as described herein. Similarly, in the illustrated example, the sidewall 306 has a greater degree of curvature, relative to the vertical axis A₃, at the lateral sides 316, 318 than at longitudinal ends 312, 314 of the sidewall 306. The greater degree of curvature of the sidewall 306 at the laterally horizontal sides translates to the ratio of D₁ to D₂ being smaller than the ratio of D₃ to D₄.

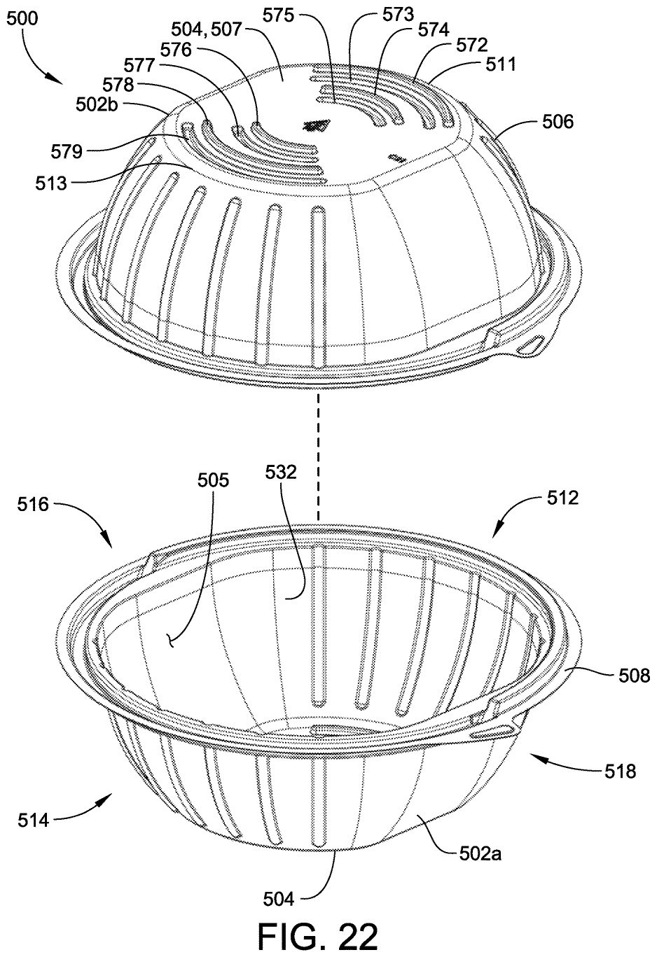

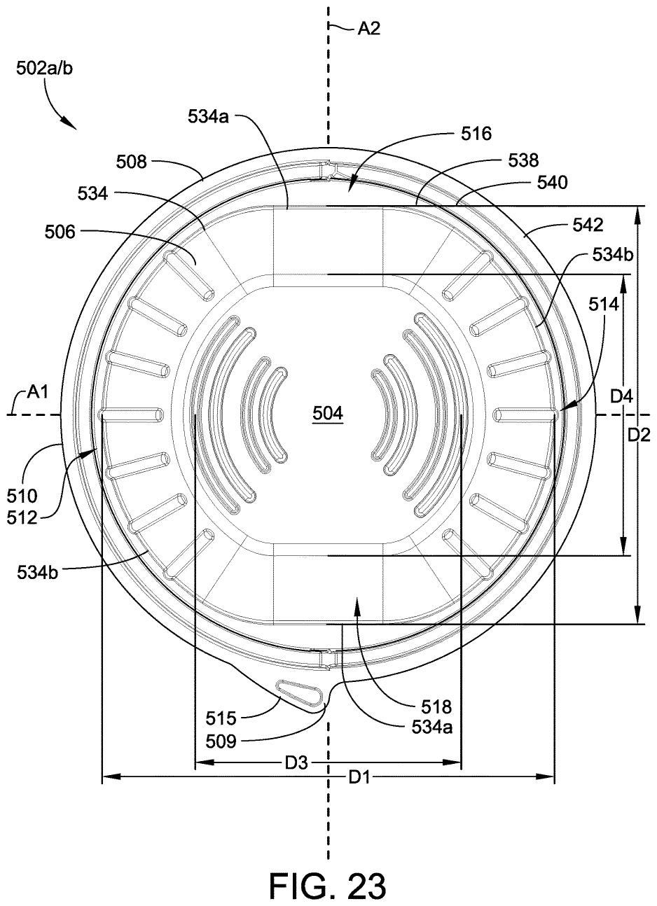

FIG. 22 depicts an exploded view of an alternative container 500 that is used to transport and/or store contents, such as food items. FIG. 23 depicts an isolated view of one of the substantially identically-profiled shells 502a and 502b that form the container 500. The container 500 and shells 502a, 502b are substantially the same as the container 300 and shells 302a, 302b shown in FIGS. 18-21, except as otherwise described differently herein. Like reference numerals are used for similar components in containers 100, 300, and 500. In particular, among the differences described herein with container 300, the container 500 includes additional stacking members 574, 575, 576, and 577.

The cover portion 504 includes a substantially flat or planar top surface 507 extending across the sidewall 506. The cover portion 504 also includes eight stacking members 572, 573, 574, 575, 576, 577, 578, 579. That stacking members 572-579 are each positioned on the top surface 507 and either extend outwardly from the top surface 507 or are recessed inwardly of the top surface 507. The stacking members 572-579 each have a curved arched shape. In other embodiments, one or more of the stacking members 572-579 may have angled shape, such as the U-shaped stacking bars 172, 174, 176, and 178 (shown in FIG. 1). The cover portion 504 may be contoured (e.g., dome-shaped) or have other non-planar features (e.g., raised features and/or indented features) in addition to or in the alternative to the stacking member 572-579 in some examples.

In the illustrated example, the stacking members 572, 579 are each positioned proximate a peripheral edge of the cover portion 504 adjacent the sidewall 506 and extend along an arc corresponding to a curvature of the sidewall 506 about the vertical axis A₃. In particular, in the illustrated example, the stacking members 572, 579 extend in parallel to curved distal edges 511, 515 of the cover portion 504, respectively. The stacking members 573, 578 are each respectively located inboard of the stacking members 572, 579 and extend in an arc parallel to the stacking members 572, 579 and distal edges 511, 515. Likewise the stacking members 574, 577 are positioned inboard of the stacking members 572, 579 and the radially innermost stacking members 575, 576.

In the illustrated example, the stacking members 572, 574, 576, and 578 each project outwardly from the cover portion 504 and the stacking members 573, 575, 577, and 579 are each recessed inwardly on the cover portion 104 and extend into the interior 105. As such, when another shell 502a/b is inverted (e.g., rotated 180 °) relative to and stacked on the shell 502a/b, the stacking members 572 and 579 are aligned such that the projection of the stacking member 572 may be received within the recess defined by the stacking member 579. Likewise, the projection of the stacking member 578 may be received within the recess of the stacking member 573, the projection of the stacking member 574 may be received within the recess of the stacking member 577, and the projection of stacking member 576 may be received within the stacking member 575. The stacking members 572-579 thereby provide added interlocking engagements between the stacked shells 502a/b, limiting or restricting lateral movement of the stacked shells 502a/b relative to one another.

The shells 502a, 502b are shaped and proportioned in a substantially similar manner as shells 302a, 302b described herein. For example, in the illustrated embodiment, the sidewall 506 of the shell 502a/b has a substantially round hemi-ellipsoid shape and is truncated at the cover portion 504. With reference to FIG. 23, the junction 534 and the cover portion 504 each has an elliptic or oval shape. The junction 534 defines the elliptic or oval shaped opening to the interior 505 of the shell 502a/b. The junction 534 has defines two conjugate diameters D₁ and D₂. The diameter D₁ is measured between the arcuate segments 534b of the junction 534 in a direction of the longitudinally horizontal axis A₁. The diameter D₂ is measured between the straight segments 534a of the junction 534 in a direction of the laterally horizontal axis A₂.

The sidewall 506 of the shell 502a/b is curved relative to the vertical axis A₃ at the longitudinal ends 512, 514 and at the lateral sides 516, 518. The curvature of the sidewall 506 promotes downward pooling of the contents in the container 500 after mixing in the direction of the vertical axis A₃. The curvature of the sidewall 506 defines a concave shape as the sidewall 506 extends between the rim 508 and the cover portion 504. The cover portion 504 also has an elliptic or oval shape that complements the shape of the junction 534 (i.e., with straight peripheral segments adjacent the lateral sides 516, 518 and arcuate segments adjacent the longitudinal ends 512, 514). The interior 505 of the shell 502a/b has two conjugate diameters D₃ and D₄ proximate the cover portion 504. The diameter D₃, like the diameter D₁, extends in the direction of the longitudinally horizontal axis A₁ and the diameter D₄, like the diameter D₂, extends in the direction of the laterally horizontal axis A₂.

The elliptic shape of the junction 534, defined by the straight segments 534a and the arcuate segments 534b, is such that a ratio of D₁ to D₂ is greater than 1. The shell 502a/b is similarly proportioned to the shell 102a/b (FIG. 17) such that the ratio of D₁ to D₂ and the ratio of D₃ to D₄ for the shell 502a/b may be substantially similar to the shell 102a/b and each may be any value greater than 1 that enables the container 500 to function as described herein. Similarly, in the illustrated example, the sidewall 506 has a greater degree of curvature, relative to the vertical axis A₃, at the lateral sides 516, 518 than at longitudinal ends 512, 514 of the sidewall 506. The greater degree of curvature of the sidewall 506 at the laterally horizontal sides translates to the ratio of D₁ to D₂ being smaller than the ratio of D₃ to D₄.

In the illustrated embodiment, the shells 502a, 502b are larger such that the container 500, when formed, is able to contain an increased amount of food product therein relative to the container 300. In the example embodiment, the container 500 is a 48 oz. container and the container 300 is a 24 oz. container.

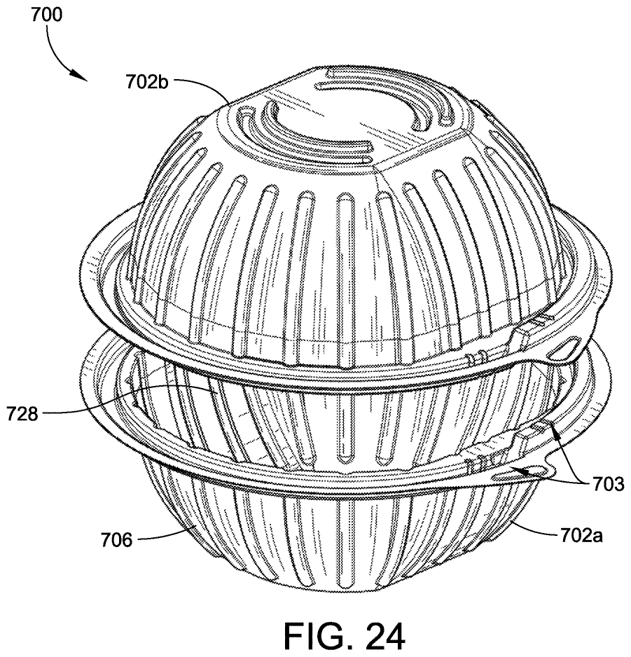

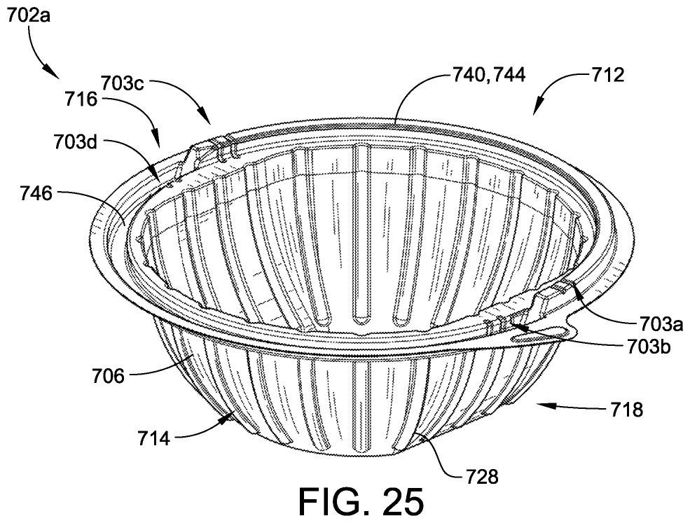

FIG. 24 depicts an exploded view of an alternative container 700 that is used to transport and/or store contents, such as food items. FIGS. 25-27 depict various isolated views of one of the substantially identically-profiled shells 702a that form the container 700. The container 700 and shells 702a, 702b are substantially the same as the container 300 and shells 302a, 302b shown in FIGS. 18-21, except as described differently herein. Like reference numerals are used for similar components in containers 100, 300, 500, 700, 900, and 700. In particular, among the differences described herein with container 300, the container 700 includes alternative venting features, such as a plurality of vent channels 703. Additionally, the container 700 includes structural ribs 728 positioned both on the longitudinal ends 712, 714 of the sidewall 706, and are on the lateral sides 716, 718.

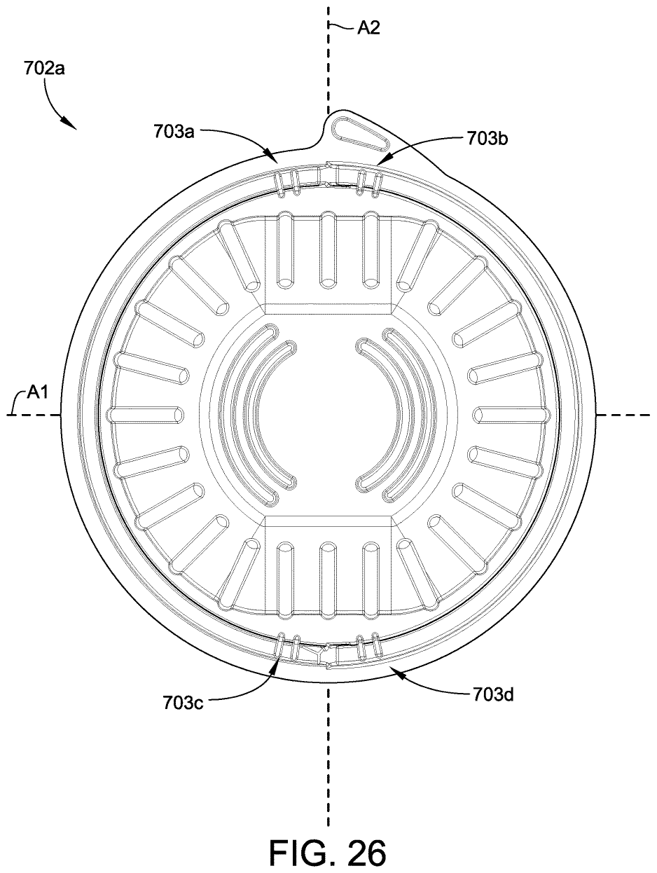

Referring to FIGS. 25 and 26, the vent channels 703 include four pairs of two vent channels 703a, 703b, 703c, and 703d (i.e., eight vent channels total). The vent channels 703 are each defined in the bead segment 740. A first pair of vent channels 703a and a third pair of the vent channels 703c are positioned at opposed ends of the upwardly-extending member 744. A second pair of the vent channels 703b and a third pair of the vent channels 703d are each positioned on opposed ends of the downwardly-extending member 746. The vent channels 703a and 703c are positioned on a first side of the axis A₂, while the vent channels 703b and 703d are positioned on a second, opposite side of the axis A₂, and are mirrored relative to the vent channels 703a and 703c, respectively, about the axis A₂. The vent channels 703 enable gas and/or vapor (e.g., steam) to be vented from the container 700 while restricting the passage of other liquids or ingredients (e.g., sauce, dressing, seasoning, etc.) present in the container 700. In other embodiments, the shells 702a, 702b may include any suitable number of vent channels 703.

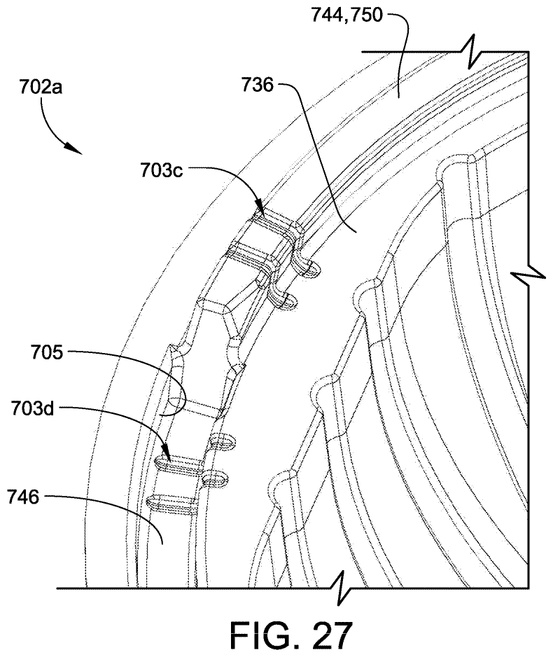

Referring to FIG. 27, the third and fourth pairs of vent channels 703c, 703d are shown. The vent channels 703c, 703d are each recessed channels and extend radially outward from the gripping portion 736. The vent channels 703c extend up the upwardly extending member 744 and radially across the bead 750. The vent channels 703d extend down the downwardly-extending member 746 and radially outward to a distal end proximate the wall 705. The first pair of vent channels and the second pair of vent channels 703a, 703b are arranged in substantially the same manner as the third and fourth pairs of vent channels 703c, 703d shown in FIG. 27.

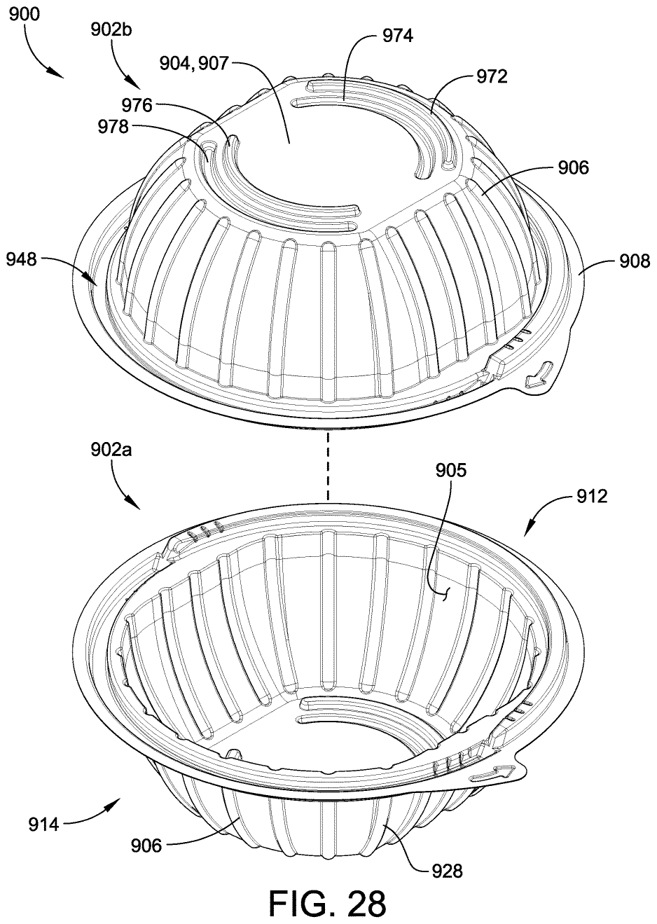

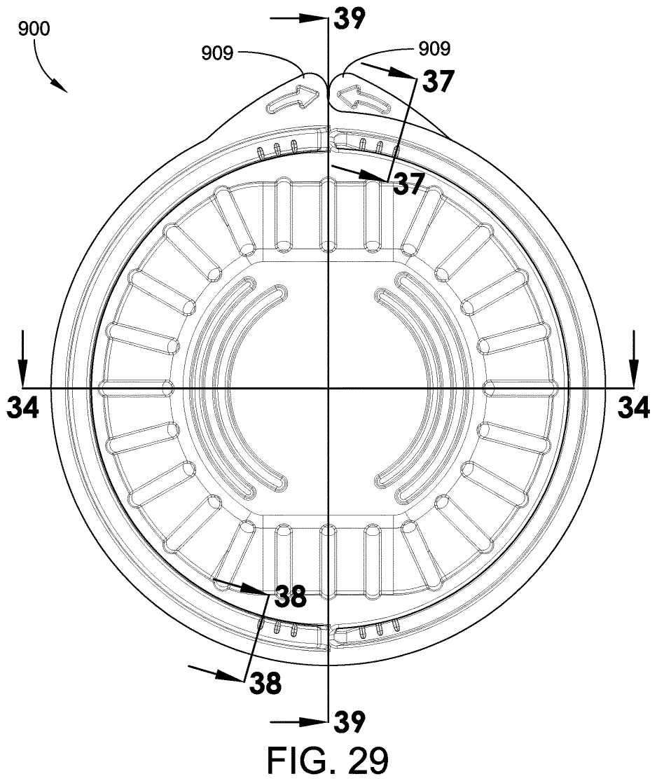

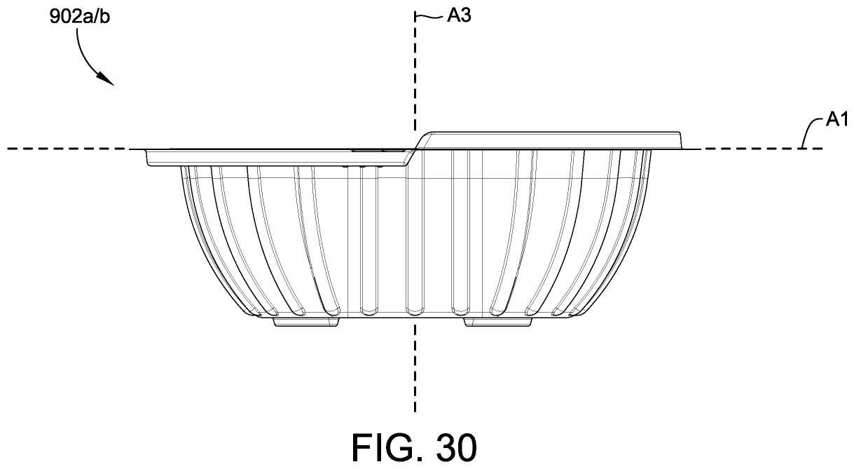

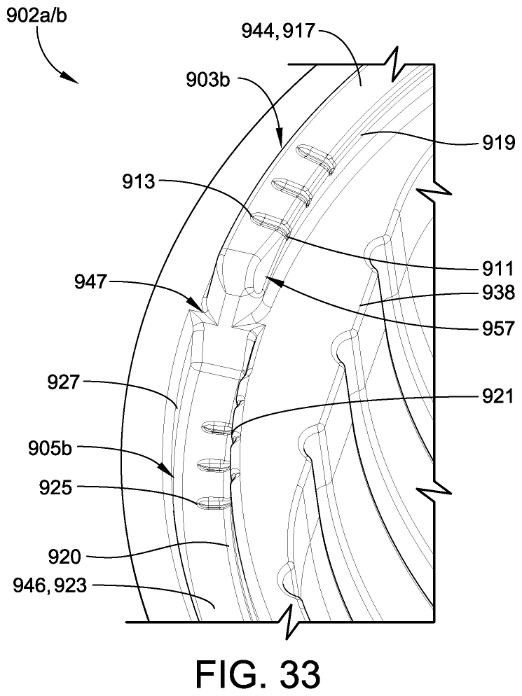

FIG. 28 depicts an exploded view of an alternative container 900 that is used to transport and/or store contents, such as food items. FIGS. 29-32 depict various isolated views of one of the substantially identically-profiled shells 902a and 902b that form the container 900. FIGS. 33-35 depict sectional views of the container 900 or a portion thereof. The container 900 and shells 902a, 902b are substantially the same as the container 700 and shells 702a, 702b shown in FIGS. 24-27, except as described differently herein. Like reference numerals are used for similar components in containers 700 and 900. In particular, among the differences described herein with container 700, the container 900 includes an increased number of vent channels 903, specifically six vent channels 903 on each side of the container 900 as compared with the four vent channels 703 on each side of the container 700, as shown in FIGS. 24-27. Additionally, the container 900 includes an alternative arrangement of tabs 909.

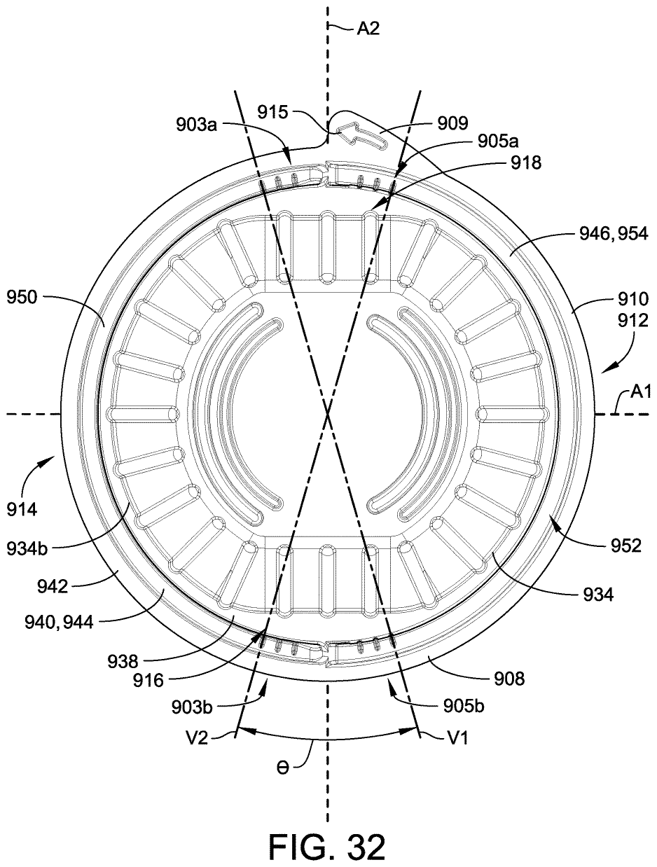

As shown in FIGS. 31 and 32, the container 900 when formed, and the shells 902a, 902b when unformed, have a first longitudinally horizontal axis A1, a second laterally horizontal axis A2 that is perpendicular to the first axis A1, and a third vertical axis A3 that is perpendicular to the axes A1 and A2. The base 902a and the lid 902b are releasably engageable with each other to selectively provide the container 900 in a closed configuration in which the base 902a and the lid 902b are engaged (e.g., similar to the closed configuration of container 100 shown in FIGS. 33-35). In the open configuration (FIG. 28) the base 902a and the lid 902b are released from each other.

Referring to FIG. 28, the example container 900 when formed has an oblong or a substantially round frusto-ellipsoid shape that facilitates improving or enhancing mixing of the contents therein. In particular, the body of the container 900, which is defined by sidewalls 906 and cover portions 904 of the base 902a and the lid 902b, has an elliptic or oval shape when viewed in a direction of the vertical axis A3 (see FIG. 31) and is truncated at a bottom of the base 902a and a top of the lid 902b. The rim 908 of the container 900 is circular, corresponding to the circular shape of the rims 908 of the base 902a and lid 902b. The base 902a and the lid 902b have substantially the same outer profile and overall footprint, and will thus be described as having a substantially identical profile.

The shell 902a/b is made of any suitable material. For example, the shell 902a/b may be made of resins or plastic materials including, but not limited to, polyethylene, polypropylene, polyvinyl chloride or polyethylene terephthalate (“PET”). The shell 902a/b may be thermoformed, blow-molded, or injection molded, or may be made using any other suitable technique. The shell 902a/b may be transparent or translucent, and may be colored or dyed in either instance.

As shown in FIG. 28, the shell 902a/b includes the cover portion 904, a sidewall 906, and a peripheral rim 908. The sidewall 906 extends between and joins the cover portion 904 and the peripheral rim 908. The sidewall 906 and the cover portion 904 define an interior 905 of the shell 902a/b. The peripheral rim 908 extends along a periphery of the shell 902a/b and envelops the interior 905. A shape of the rim 908 and a shape of the sidewall 906 cooperate to define the shape of the shell 902a/b. The sidewall 906 includes two longitudinal ends 912, 914 and two lateral sides 916, 918. The lateral sides 916, 918 of the sidewall 906 are truncated at the rim 908 relative to the longitudinal ends 912, 914. As such, the sidewall 906 defines an elliptic or oval opening (shown in FIG. 33) to the interior 905 of the shell 902a/b . The shape of the shell 902a/b, which, when engaged with another shell 902a/b, defines the container 900 having the circular rim 908 and a substantially an oblong or substantially round frusto-ellipsoid shape body.

The cover portion 904 includes a substantially flat or planar top surface 907 extending across the sidewall 906. The cover portion 904 also includes stacking members 972, 974, 976, and 978 that are positioned on the top surface and either extend outwardly from the top surface 907 or are recessed inwardly of the top surface 907. The stacking members 972, 974, 976, and 978 are substantially the same as the stacking members 372, 374, 376, and 398 as described with respect to FIGS. 18-21. In the illustrated example, the sidewall 906 includes structural ribs 928 that are substantially the same as the structural ribs 728 described with respect to FIGS. 24-27.

Referring to FIG. 32, the rim 908 is generally circular in shape along its peripheral edge 910. The rim 908 extends between the peripheral edge 910 and the sidewall 906, and meets the sidewall 906 at a junction 934. A radial length of the rim 908 between the peripheral edge 910 and the junction 934 varies because the lateral sides 916, 918 of the sidewall 906 are truncated at the junction 934 relative to the longitudinal ends 912, 914. The junction 934 includes straight segments 934a between the lateral sides 916, 918 of the sidewall 906 and the rim 908, and arcuate segments 934b between the longitudinal ends 912, 914 of the sidewall 906 and the rim 908. The curvature of the arcuate segments 934b of the junction 934 substantially matches the curvature of the peripheral edge 910 of the rim 908, such that a radial length of the rim 908 is substantially constant between the peripheral edge 910 and arcuate segments 934b of the junction 934 as the rim 908 extends circumferentially. The straight segments 934a of the junction 934 cause the radial length of the rim 908 to increase to a maximum radial length, measured between the junction 934 and the peripheral edge 910 in a direction of the laterally horizontal axis A2.

The rim 908 includes the proximal segment 938, a bead segment 940, and a distal segment 942. The proximal segment 938 extends outwardly from the junction 934 to the bead segment 940. The bead segment 940 extends outwardly from the proximal segment 938 to the distal segment 942. The distal segment 942 extends outwardly from the bead segment 940 and terminates at the peripheral edge 910 of the rim 908. Collectively, a radial distance extended by the proximal segment 938, the bead segment 940, and the distal segment 942 is approximately equal to the radial length of the rim 908. The extent of the proximal segment 938 increases in radial distance as the radial length of the rim 908 increases at the lateral sides 916, 918. The bead segment 940 and the distal segment 942 have a substantially constant radial extent along the circumferential extent of the rim 908. In the illustrated example, the proximal segment 938 and the distal segment 942 are substantially flat or planar. When the container 900 is closed, the rims 908 of the shells 902a and 902b are at least partially in face-to-face contact. For example, the proximal segments 938, the bead segments 940, and/or the distal segments 942 of the shells 902a and 902b are respectively in face-to-face contact when the shells are engaged and the container 900 is closed.

Referring to FIG. 32, the shells 902a/b includes a single tab 909 extending radially outwardly from the peripheral edge 910 of the rim 908, though in other embodiments, the shell 902a/b may include two, three, or any suitable number of tabs 909. The tab 909 includes an indent 915 (broadly an identifying member) extending inwardly in the direction of the vertical axis A3 away from the cover portion 904, such that the indent 915 extends away from the other of shell 902a/902b, when the container 900 is formed. As shown in FIG. 29, when the container 900 is formed, the tab 909 of the first shell 902a at least partially overlaps the tab 909 of the second shell 902b and the projections are oriented in a mirrored orientation relative to one another. The tabs 909 are sized and shaped to enable a user to grasp the tabs 909, when the container 900 is formed, to peel the tabs 909 of the shells 902a, 902b apart to open the container 900. The indents 915 provide recessed areas between the rims 908 of the shells 902a, 902b to provide a grip for a user to separate the shells 902a, 902b. Any number of tabs 909 may be included, and the tab(s) 909 may be included at any location along the rim 908. In other embodiments the indents may be projections, similar to projection 315 described with respect to FIG. 18.

Referring to FIG. 32, the bead segment 940 includes an upwardly-extending member 944 and a downwardly-extending member 946. The upwardly-extending member 944 defines a first cavity 948 (FIG. 28) and includes an upper bead 950. The upper bead 950 is spaced above (e.g., raised relative to) the proximal segment 938 and the distal segment 942. The distance that the upper bead 950 is spaced above the proximal segment 938 and the distal segment 942 may be referred to as a height of the upper bead 950. The downwardly-extending member 946 defines a second cavity 952 and includes a lower bead 954. The lower bead 954 is spaced below (e.g., lowered relative to) the proximal segment 938 and the distal segment 942. The distance that the lower bead 954 is spaced below the proximal segment 938 and the distal segment 942 may be referred to as a height of the lower bead 954.

The upwardly-extending member 944 and the downwardly-extending member 946 of the shell 902a/b each extend along the bead segment 940 of the rim 908 to envelop a substantial portion of the proximal segment 938. The upwardly-extending member 944 and the downwardly-extending member 946 may each have a substantially constant dimension or cross-sectional profile along their respective extent.

In the example embodiment, the upwardly-extending member 944 extends between a first end 956 and a second end 958. The downwardly-extending member 946 extends between a first end 960 and a second end 962. The first end 956 of the upwardly-extending member 944 is located proximate the second end 962 of the downwardly-extending member 946, and the second end 958 of the upwardly-extending member 944 is located proximate the first end 960 of the downwardly-extending member 946. The upwardly-extending member 944 and the downwardly-extending member 946 terminate at their respective ends prior to reaching the proximate end of the other member 944, 946. In the example embodiment, the second end of the downwardly-extending member 946 is oriented obliquely relative to the first end 956 of the upwardly extending member 944. In the example embodiment, the first end 956 of the upwardly-extending member 944 includes a cut-away section 957 on an internal facing side of the upwardly extending member 944. When the container 900 is assembled a gap (similar to gap G shown in FIGS. 9 and 91) is defined between the ends 956, 962 and defined at least in part by the cut-away sections 957 of the corresponding upwardly extending members 944.

The sidewall 906 of the shell 902a/b is oblong in shape with a tapered diameter between the rim 908 and the cover portion 904. When the two shells 902a, 902b are inverted relative to one another and engaged to form the container 900, the oblong or substantially round frusto-ellipsoid shape of the container 900 with the circular rim 908 is defined. Additionally, when the container 900 is formed, the two shells 902a, 902b having the substantially identical profiles define a substantially mirror-image relative to planes respectively defined by the horizontal axes A3 and A2, the longitudinally horizontal axis A3 and the vertical axis A3, and the laterally horizontal axis A2 and the vertical axis A3. The interiors 905 of the two shells 902a, 902b cooperatively form a mixing chamber of the closed container 900 for mixing contents therein.

In the illustrated example, the sidewall 906 of the shell 902a/b has a substantially round hemi-ellipsoid shape and is truncated at the cover portion 904. With reference to FIG. 32, the junction 934 and the cover portion 904 each have an elliptic or oval shape. The junction 934 defines the elliptic or oval shaped opening to the interior 905 of the shell 902a/b. The junction 934 defines two conjugate diameters. The shell 902a/b is similarly shaped and proportioned to the shells 102a/b (FIGS. 1), 302a/b (FIGS. 18), 502a/b (FIG. 22), and 702a/b (FIG. 24) such that the ratio of conjugate diameters D1 to D2 and the ratio of D3 to D4 for the shell 902a/b may be substantially similar to the shell 102a/b and each may be any value greater than 1 that enables the container 900 to function as described herein.

Referring to FIG. 32, in the example embodiment the shells 902a/b each include vent channels 903, 905. The vent channels 903, 905 include four pairs of three vent channels 903a, 903b, 903c, 903d such that there are six vent channels on each end 916, 918, or 12 vent channels in total.

The vent channels 903, 905 are each defined in the bead segment 940. A first pair of vent channels 903a and a second pair of the vent channels 903b are positioned at opposed ends of the upwardly-extending member 944. A third pair of the vent channels 905a and a fourth pair of the vent channels 905d are each positioned on opposed ends of the downwardly-extending member 746. The vent channels 903, 905 enable gas and/or vapor (e.g., steam) to be vented from the container 900 while restricting the passage of other liquids or ingredients (e.g., sauce, dressing, seasoning, etc.) present in the container 900 in substantially the same manner as described with respect to vent channels 703 (FIG. 27). In the example embodiment, the first pair of vent channels 903a and the second pair of vent channels 903b (broadly referred to herein as “upper bead vent channels”) are each substantially identical to one another, except that the vent channels are mirrored about the A2 axis. Similarly, the third pair of vent channels 905a and the fourth pair of vent channels 905b (broadly referred to herein as “lower bead vent channels”) are each substantially identical to one another, except that the vent channels are mirrored about the A2 axis.

In the example embodiment, the vent channels 903, 905 are positioned at the sides 916, 918 to facilitate closing and/or narrowing vent paths defined by the vent channels 903, 905 when the container 900 is gripped at the sides 916, 918 and rotated by the user. For example, the vent channels 903, 905 are each positioned within an angular range defined between a first vent axis V1 and a second vent axis V2 that each extend through an outermost edge of outermost vent channels 903, 905, as shown in FIG. 32. In the example embodiment, the vent axes V1, V2 are each mirrored about the A2 axis such that the outermost vent channels 903, 905 on each end 916, 918 are positioned at an equal angular offset relative to the center axis A2. As a result, when the container 900 is gripped by a user at the sides 916, 918, and specifically as indicated to the user by the tab 909 and indent 915, a pinching force is centered generally at the A2 axis for pinching the vent channels 903, 905. The angular range θ is suitably less than or equal to 120 degrees, less than or equal to 90 degrees, less than or equal to 60 degrees, less than or equal to 45 degrees, and/or less than or equal to 30 degrees. In the example embodiment, the angular range is approximately 35 degrees and each of the outermost vent channels are offset from the axis A2 by approximately 17.5 degrees.

Referring to FIG. 33, the second pair of vent channels 903b and the fourth pair of vent channels 905b are shown. The vent channels 903b, 905b are each recessed channels and extend radially outward from the gripping portion 736. The upper bead vent channels 903b extend from a first end 911 on an interior side wall 919 of the upwardly extending member 944 and radially across an upper wall 917 of the upwardly extending member 944 to a second end 913 on the upper wall 917. The lower bead vent channels 905b extend from a first end 921 on the gripping portion down an interior side wall 920 of the downwardly extending member 746 and radially across an lower wall 923 of the downwardly extending member 946 to a second end 925 on the lower wall 923 and extending at least partially along an intersection of the lower wall 923 with the outer wall 927. As shown in FIG. 33, each of the vent channels has a generally “U” shaped profile along a radial length of the respective vent channels 903, 905 and is at least partially tapered in a vertical direction, such that the height of the vent channels 903, 905 proximate the ends of the channels 903, 905 is less than the depth of the channels 903, 905 at an intermediate position between the first and second ends 911, 913, 921, 925.

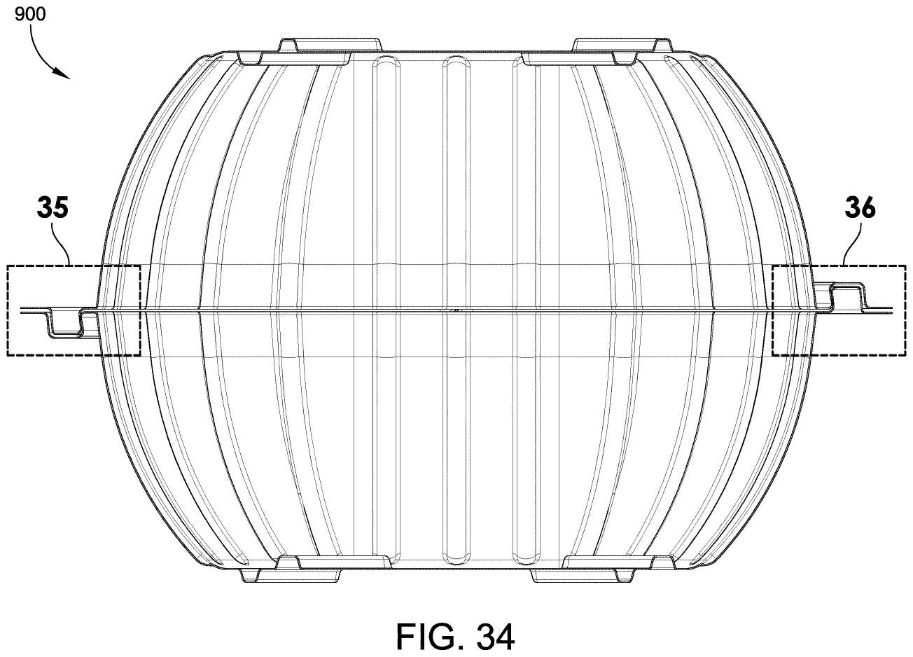

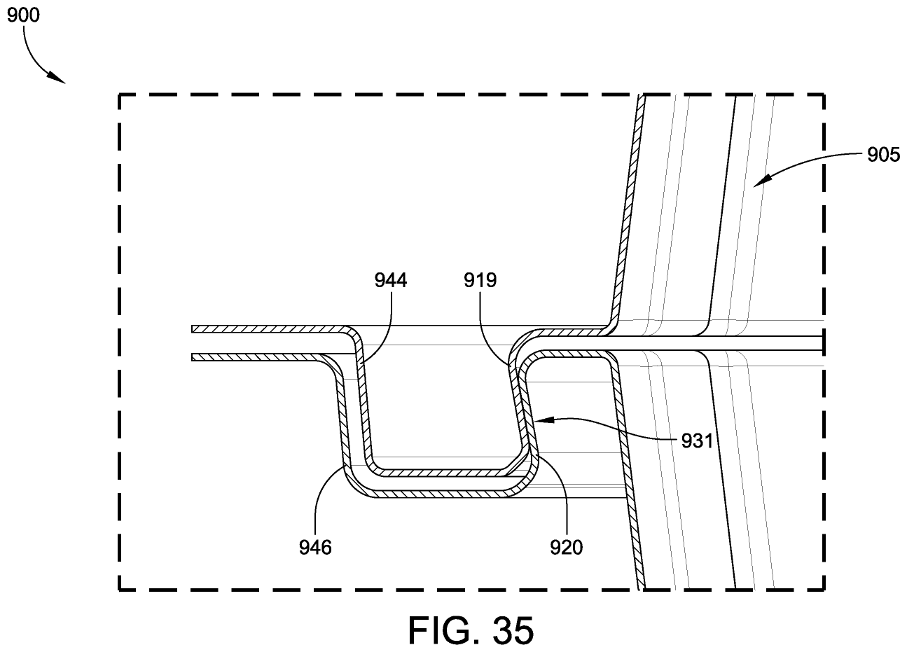

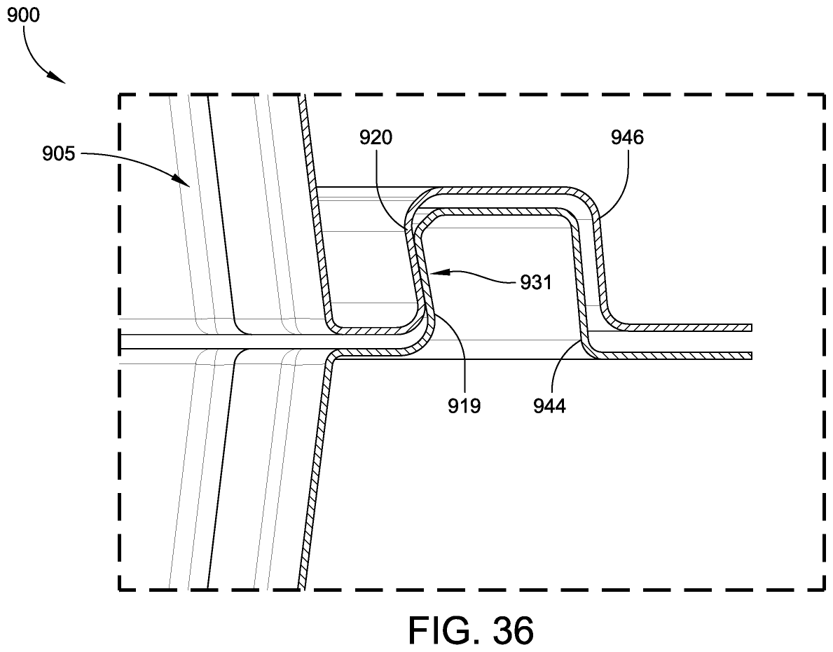

FIG. 34 shows a cross section view of the container 900 taken along the line 34 -34 shown in FIG. 29. FIGS. 35 and 36 shows an enlarged views of the regions 35 and 36, respectively, shown in FIG. 34. In particular, FIGS. 35 and 36 show portions of the members 944, 946.

Referring to FIGS. 35 and 36, the upwardly-extending member 944 and the lower bead 946 are each sized and shaped such that, at the regions of the rim 908 at which the vents channels 903, 905 are not present as in FIGS. 35 and 36, a seal 931 is formed radially outside of the proximal segment 938. In particular, the interior wall 919 of the upwardly-extending member 944 contacts and seals against the interior wall 920 of the lower bead segment 946, such that sauce, moisture, or other food items present within the interior 905 of the container 900 are not able to leak out of the container 900.

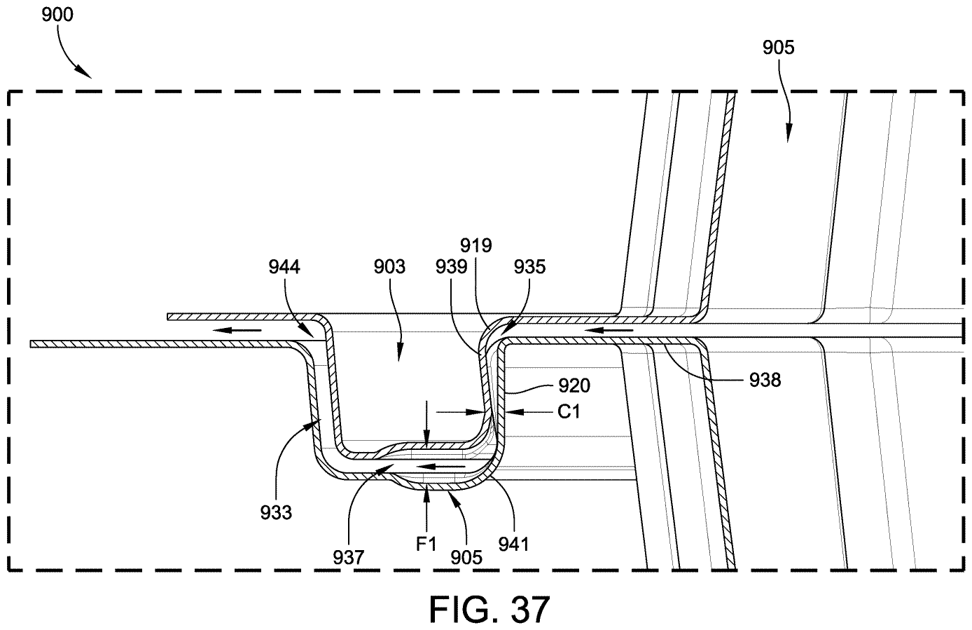

FIG. 37 shows a cross-section view of the container 900 taken along the line 37 -37 shown in FIG. 29. As shown in FIG. 37, the upper bead vent channel 903 and the lower bead vent channel 905 collectively define a radial vent path 933 through which interior gases may vent from the interior 905 to outside of the container 900. The upwardly extending member 944 includes an upper bead vent wall 939 which defines the upper bead vent channel 903. The downwardly extending member 946 includes a lower bead vent wall 941 which defines the lower bead vent channel 905. The upper bead vent channel 903 and the lower bead vent channel 905 are aligned, when the container 900 is formed to collectively as shown in FIG. 37 to collectively form the vent path 933.

The vent path 933 includes a constricting section 935 and a flow section 937. The constricting section 935 is defined as a section of the vent path in which a shortest distance between the upper bead vent wall 939 and the lower bead vent wall 941 is at its shortest. The flow section is defined as a section of the vent path 933 in which the shortest distance between the upper bead vent wall 939 and the lower bead vent wall 941 is at its greatest. As shown in FIG. 37, the vent wall 939 extends from the proximal segment 938 (shown in FIG. 32) and tapers inward toward the vent wall 941 such that the vent wall is oriented obliquely relative to the vent wall 941 about the constricting section.

In the example embodiment, the constricting section 935 is positioned between the interior walls 919, 920, and in particular, at a region of the interior wall that is closest to the proximal segment 938 and is oriented generally in a vertical direction (i.e., in a direction of the A3 axis). The constricting section 935 has a height, indicated at C1. The height of the constricting section 935 is sized to limit ingress of sauce and/or food materials within sauce from entering the channel and such that, when the container 900 is held by the user, the constricting section 935 is closed by a pinching force of the user holding the container at the sides 916, 918 (shown in FIG. 32).

The flow section 937 is positioned downstream from the constricting section and between the portion of the vent channels 903, 905 that extend along the walls 917, 923 (shown in FIG. 33). The flow section 937 has a height, indicated at F1. The height of the flow section F1 is greater than a height of the vent path downstream of the flow section and defines the largest height of the vent path. The constricting section 935 and/or the flow section 937 are each collectively sized such that, collectively, when a pinching force is not applied on the container 900 from a user holding the container 900, high pressure air/steam within the container is able to vent through the constricting sections 935 of the vent paths 933, collectively, to prevent pressure within the container from building to a sufficient level to cause the shells 902a/b to become dislodged and/or “pop” loose from one another.

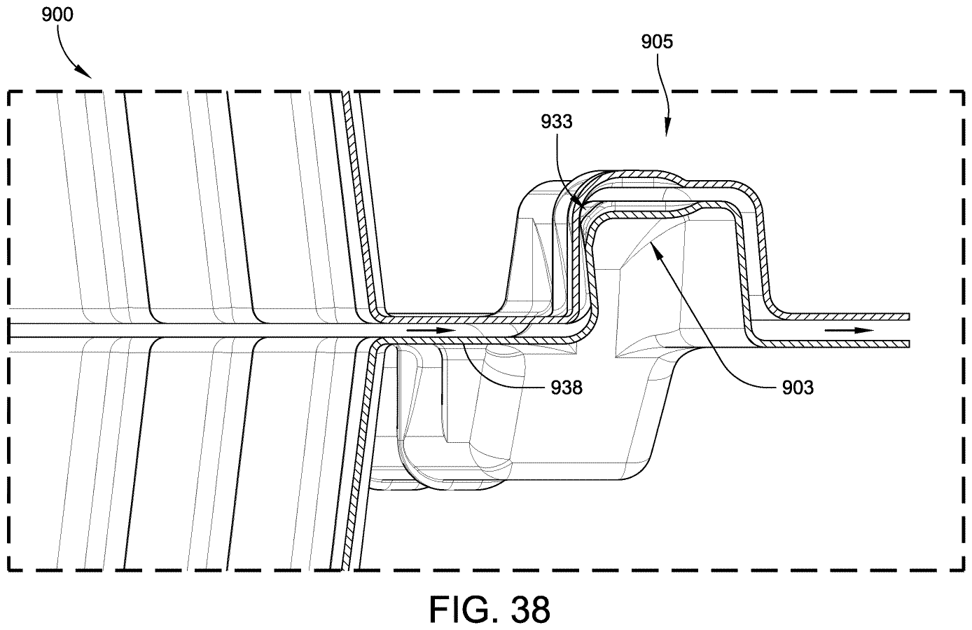

Referring to FIG. 38, which shows a cross-section view taken along the line 38 -38 shown in FIG. 29, the vent path 933 is substantially the same as the vent path 933 shown in FIG. 37, except that the arrangement is mirrored about the A2 axis and rotated approximately 180 degrees about the A3 axis, as shown in FIG. 31.

Referring back to FIG. 33, in the example embodiment the shells 902a/b each include ramp sections 947 which define a transition between the upwardly-extending segment 944 and the lower extending segment 946. The ramp sections 947 include a cut-away section 957 that is similar to the cut-away section 357 shown in FIG. 18. Similar to the containers 100, 300, 500, 700, 900, and 700, when the container is assembled a gap G is formed between the ramp sections 947 to define an additional vent channel to facilitate venting of the container 900.

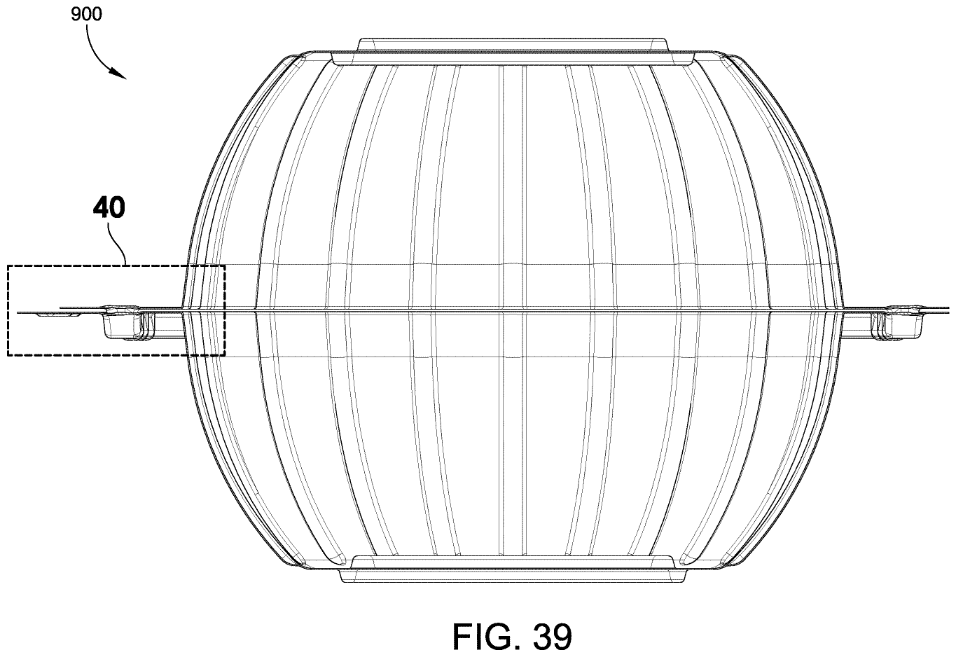

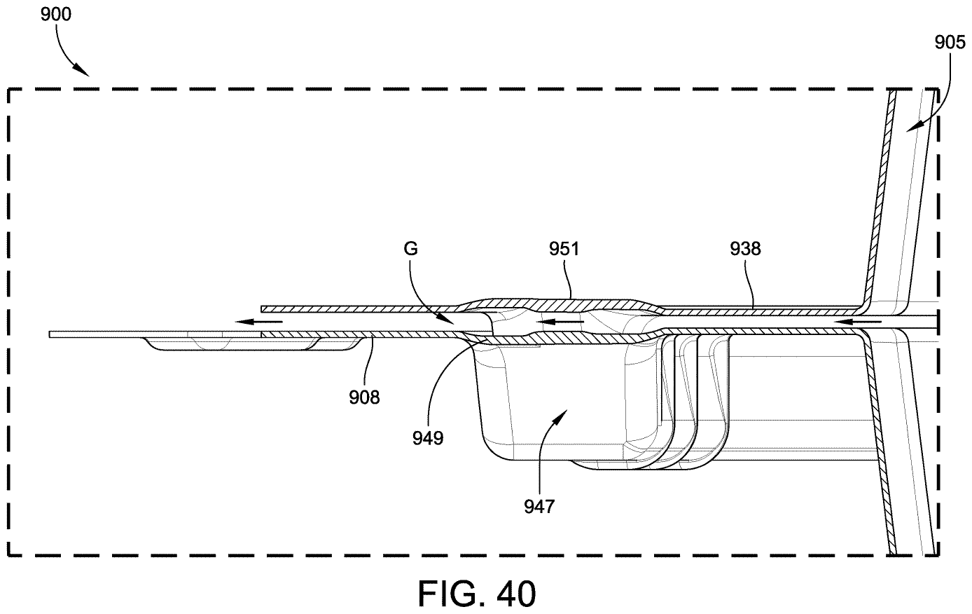

FIG. 39 shows a cross-section view of the container 900 taken along the line 39-39, shown in FIG. 29. FIG. 40 shows an enlarged view of the region 40 shown in FIG. 39. As shown in FIG. 40, the gap G is defined between a first ramp wall 949 and a second ramp wall 951 on the base 902a and lid 902b, respectively. The ramp walls 951, 947 provide a substantially linear and radial vent path between the ramp sections 947 of the lid and the base.

Referring generally to FIGS. 1-40, a method of using the containers 100, 300, 500, 700, 900, and in particular a method of mixing contents in the mixing chamber using the containers 100, 300, 500, 700, 900, includes placing contents within the interiors 105, 305, 505, 705, 905 of the base 102a, 302a, 502a, 702a, 902a and lid 102b, 302b, 502b, 702b, 902b when the container 100, 300, 500, 700, 900 is open and then forming or closing the container 100, 300, 500, 700, 900 by engaging the rims 108, 308, 508, 708, 908 to enclose the contents. The rims 108, 308, 508, 708, 908 of the 102a, 302a, 502a, 702a, 902a and the lid 102b, 302b, 502b, 702b, 902b engage as described above to form the peripheral seal of the closed 100, 300, 500, 700, 900.

The method also includes manually mixing the contents in the mixing chamber by rotating the container 100, 300, 500, 700, 900 about the laterally horizontal axis A₂, and in particular by reciprocating rotation of the container 100, 300, 500, 700, 900 about the axis A₂ between the forward rotational direction R₃ and the backward rotational direction R₂ (shown in FIGS. 2 and 3). Suitably, the user rotates the container 100, 300, 500, 700, 900 about the laterally horizontal axis A₂ using the grips 370 of the container 100, 300, 500, 700, 900. During rotation of the container 100, 300, 500, 700, 900 about the axis A₂, the contents reciprocate between the interiors 305 of the base 102a, 302a, 502a, 702a, 902a and the lid 102b, 302b, 502b, 702b, 902b. The reciprocating movement of the contents between the interiors 305 is enabled by the heights H of the base 102a, 302a, 502a, 702a, 902a and the lid 102b, 302b, 502b, 702b, 902b, which respectively define a depth of the interiors. The contents are centered during rotation of the container 100, 300, 500, 700, 900 about the axis A₂ relative to the plane defined by the axes A₃ and A₃. The centering of the contents about this plane is enabled by the ratios of the ratio of the conjugate diameters D₃ and D₂ and D₃ and D₄ as described above. The centering of the contents and the reciprocating movement thereof results in enhanced mixing of the contents without the user having to shake the container, or rotate the container about axes other than the laterally horizontal axis A₂. After mixing, the curvature profiles of the sidewalls 106, 306, 506, 706, 906 and the smooth contour of the inner surface 132, 332, 532, 732, 932 of the sidewalls 106, 306, 506, 706, 906 along the lateral sides 116, 118, 316, 318, 516, 518 promotes downward pooling of the contents in the direction of the vertical axis A₃.

The above-described embodiments described herein relate to containers that can be used to transport, store, and manually mixing contents therein. The example containers can be used in various applications, including, for example, for applying sauce and/or seasoning to chicken wings and mixing salad, such as with a dressing. The example containers are sized to improve or enhance mixing of the contents therein during rotation about a single axis. In particular, the example containers have a round frusto-ellipsoid shape, with a mixing chamber of the container defining two conjugate diameters at a center thereof having a diameter ratio greater than 1. The greater diameter at the center of the mixing chamber extends about a longitudinally horizontal axis and the smaller diameter at the center of the mixing chamber extends about a laterally horizontal axis. The container is rotated about the laterally horizontal axis, and the smaller diameter facilitates limiting or reducing a deviation of the contents from a central longitudinal plane. This keeps the contents centered in the container during rotation for enhanced mixing. The mixing chamber of the container is also defined by two chambers of the lid and the base of the container, which are each sized for reciprocating movement of the contents therebetween during rotation for better mixing. The sidewalls of the lid and the base are each curved and at least a portion of the sidewalls has a smooth inner surface, which enables the contents to pool downward in the container after mixing, and the curvature profiles of the sidewalls results in the conjugate diameters of the mixing chamber being tapered towards the top and the bottom of the container. The tapered diameters of the mixing chamber allow for enhanced mixing by further keeping the contents centered relative to the longitudinal plane during rotation.

Additionally, the above-described embodiments include mixing containers that are formed from two shells having substantially identical profiles. This enables efficient storage and stacking of the containers, simplifies assembly, and improves inventory management.

Advantages provided by the above-described embodiments described herein may include, but are not limited to only including: (i) improving or enhancing manual mixing of contents within a container while reducing the amount of time and/or effort and awkward movement required for mixing, (ii) ensuring a consistent and repeatable manual mixing method using the container, (iii) reducing a size or footprint of the container without sacrificing the ability to achieve sufficient mixing of the contents therein, (iv) providing grips on the container to allow the user to rotate the container in the appropriate rotational directions for mixing, (vi) allowing steam and heat to vent from the container, (vii) allowing for multiple containers to be stacked on top of one another using complementing stacking features at the top and bottom of the container and the structural ribs for increasing stacking load capacity of the container, (viii) shaping the structural ribs such that the user can handle the container while the heat transfer surface area contact between the container and the user's hands is reduced or minimized, (ix) strategically positioning the structural ribs such that the sidewalls of the container include smooth portions for promoting downward pooling of contents after mixing, (x) strategically positioning the grips of the container such that each grip can be laterally grasped by a hand of the user and used to easily and comfortably rotate the container in the appropriate directions for mixing while also operating to create reliable seals at locations of the closed container that are susceptible to leakage, (xi) enabling efficient storage and stacking of containers and/or shells that form the containers, (xii) simplifying container assembly and improving inventory management, (xiii) reducing entrapped moisture within the container with minimal liquid leakage from the container, (xiv) reducing negative impact of entrapped moisture in the container on food texture and/or taste, (xv) enabling secure stacking of multiple containers when in use, (xvi) improving balance of a container on a surface; and/or (xvii) enabling easy separation of shells from one another when multiple shells are stacked by denesting features, (xviii) improving consistency in distribution of sauce and/or seasoning on food products mixed within the containers, (xix) reducing or preventing leakage of the contents from the container, (xx) enabling continuous venting of the containers when the containers are positioned in a heated storage area, such as under a heat lamp, in a hot hold cabinet, or on a heated shelf. Additional advantages will be apparent to those skilled in the art from the above-description of example embodiments.

As used herein, an element or step recited in the singular and preceded by the word “a” or “an” should be understood as not excluding plural elements or steps, unless such exclusion is explicitly recited. References to “example embodiment” or “one embodiment” are not intended to be interpreted as excluding the existence of additional embodiments that also incorporate the recited features. Moreover, although specific features of various embodiments described herein may be shown in some drawings and not in others, this is for convenience only. In accordance with the principles of the present disclosure, any feature of a drawing and/or embodiment described herein may be referenced and/or claimed in combination with any feature of any other drawing and/or embodiment described herein. Furthermore, unless explicitly stated to the contrary, embodiments “including” or “having” an element or a plurality of elements having a particular property may include additional such elements not having that property.

Unless otherwise indicated, approximating language, such as “generally,” “substantially,” “approximately,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value.

Unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A container for manually mixing contents therein, the container when formed having a first longitudinally horizontal axis A₁, a second laterally horizontal axis A₂, and a vertical axis A₃ that is perpendicular to the horizontal axes A₁ and A₂, the container comprising a first shell defining a base chamber and a second shell defining a lid chamber and releasably engageable with the first shell when inverted relative to the first shell, wherein the first shell and the second shell have a substantially identical profile, each of the first and second shells comprising:
a cover portion, a rim, and a sidewall extending between the cover portion and the rim in a direction of the vertical axis A₃ and defining an interior of the shell, wherein the rim defines an elliptic-shaped opening to the interior, wherein the interior has two conjugate diameters D₁ and D₂ proximate the opening and two conjugate diameters D₃ and D₄ proximate the cover portion, wherein the diameters D₁ and D₃ extend in a direction of the longitudinally horizontal axis A₁ and the diameters D₂ and D₄ extend in a direction of the laterally horizontal axis A₂, and wherein a ratio of D₁ to D₂ is greater than 1 and a ratio of D₃ to D₄ is greater than 1.

2. The container of claim 1, wherein the ratio of D₁ to D₂ and the ratio of D₃ to D₄ facilitate centering the contents within the base and lid chambers relative to a plane defined by the longitudinally horizontal axis A₁ and the vertical axis A₃ during rotation of the container about the laterally horizontal axis A₂.

3. The container of claim 1, wherein the ratio of D₁ to D₂ and the ratio of D₃ to D₄ are each independently between 1.05 to 1.25.

4. The container of claim 1, further comprising grips extending outwardly from the container when formed, each grip sized, shaped, and positioned to be grasped by a hand of a user for manually mixing the contents within the base and lid chambers by rotating the container about the laterally horizontal axis A₂, wherein:
for each shell, the rim includes a proximal segment extending outwardly from the sidewall and a bead segment extending outwardly from the proximal segment,
the bead segments of the rims of the first and second shells engage one another when the container is closed, and
the grips are defined by the proximal segments of the rims of the first and second shells, such that the grips are located inboard of the engaged bead segments.

5. The container of claim 1, wherein the sidewalls of the first and second shells are curved relative to the vertical axis A₃ to promote downward pooling of the contents in the direction of the vertical axis A₃ after mixing, wherein the sidewalls of the first and second shells each has a greater degree of curvature, relative to the vertical axis A₃, at lateral sides of the sidewall than at longitudinal ends of the sidewall, such that the ratio of D₁ to D₂ is smaller than the ratio of D₃ to D₄, and wherein the longitudinal ends of the sidewalls of the first and second shells each include structural ribs extending in the direction of the vertical axis A₃ and outwardly from the respective sidewall.

6. The container of claim 1, wherein the sidewalls of the first and second shells each include structural ribs extending in the direction of the vertical axis A₃ and outwardly from the respective sidewall, wherein the structural ribs have at least one of a V-shape and U-shape, the structural ribs further tapering to a reduced surface area at a terminal outer point of the ribs.

7. The container of claim 1, wherein: for each shell, the rim includes an upwardly-extending member and a downwardly-extending member each extending circumferentially between a first end and a second end, the first end of the upwardly-extending member being proximate the second end of the downwardly-extending member, and the first end of the downwardly-extending member being proximate the second end of the upwardly-extending member.

8. The container of claim 7, when the container is closed, the upwardly-extending member of the first shell is received by and engages the downwardly-extending member of the second shell, and the upwardly-extending member of the second shell is received by and engages the downwardly-extending member of the first shell, wherein the rims of the first and second shell each define gripping areas inboard of the upwardly-extending member and the downwardly-extending member, one of the gripping areas being adjacent and inboard of a gap between the first end of the upwardly-extending member and the second end of the downwardly-extending member, and another one of the gripping areas being adjacent and inboard of a gap between the first end of the downwardly-extending member and the second end of the upwardly-extending member.

9. The container of claim 8 further comprising at least one vent channel extending through at least one of the gap between the first end of the upwardly-extending member and the second end of the downwardly-extending member and the gap between the first end of the downwardly-extending member and the second end of the upwardly-extending member.

10. The container of claim 1, wherein, for each of the first and second shells, a peripheral edge of the rim is circular in shape.

11. The container of claim 1, wherein, for each of the first and second shells, the rim meets the sidewall at a junction, wherein the junction includes two arcuate segments that define the diameter D₁ and two straight segments that define the diameter D₂, and wherein, for each of the first and second shells, the straight segments of the junction each immediately transition to the arcuate segments of the junction.

12. The container of claim 1 wherein, for each shell, the rim comprises:
a proximal segment extending outwardly from the sidewall;
a bead segment extending outwardly from the proximal segment; and
at least one vent channel defined in the bead segment, the at least one vent channel extending radially in the proximal segment and the bead segment to enable venting of the container through the at least one vent channel.

13. The container of claim 12, wherein, for each shell, the bead segment comprises an upwardly-extending member and a downwardly-extending member each extending circumferentially between a first end and a second end, the first end of the upwardly-extending member being proximate the second end of the downwardly-extending member, and the first end of the downwardly-extending member being proximate the second end of the upwardly-extending member.

14. The container of claim 13, wherein the at least one vent channel includes a first vent channel and a second vent channel, the first vent channel extending up and radially across the upwardly-extending member, the second vent channel extending down and radially across the downwardly-extending member.

15. A container for manually mixing contents therein, the container comprising a first shell and a second shell releasably engageable with the first shell when inverted relative to the first shell, wherein the first shell and the second shell have a substantially identical profile, each of the first and second shells comprising:
a cover portion, a rim, and a sidewall extending between the cover portion and the rim, wherein the rim comprises;
a proximal segment extending outwardly from the sidewall;
a bead segment extending outwardly from the proximal segment; and
at least one vent channel defined in the bead segment, the at least one vent channel extending radially in the bead segment to enable venting of the container through at least one vent path defined by the at least one vent channels of the first shell and the second shell,
wherein, when the container is formed, the at least one vent path includes a constricting section and a flow section downstream of the constricting section, wherein a height of the constricting section is less than a height of the flow section, and wherein the height of the flow section is greater than a height of the vent path downstream of the flow section.

16. The container of claim 15, further comprising grips extending outwardly from the container when formed, each grip sized, shaped, and positioned to be grasped by a hand of a user for manually mixing the contents within the container by rotating the container, wherein the grips are defined by the proximal segments of the rims of the first and second shells, such that the grips are located inboard of the engaged bead segments.

17. The container of claim 16, wherein, for each shell, the sidewall includes a pair of longitudinal ends and a pair of lateral sides, including a first lateral side and a second lateral side, each positioned between the pair of longitudinal ends, wherein the grips are positioned at the lateral sides, and
wherein the at least one vent path includes a first plurality of vent paths positioned at the first lateral side and a second plurality of vent paths positioned at the second lateral side, and wherein no vent paths are positioned circumferentially between the first plurality of vent paths and the second plurality of vent paths.

18. The container of claim 17, wherein the container defines a first vent axis extending along a first pair of circumferentially opposed outermost vent paths in the first plurality of vent paths and in the second plurality of vent paths, the container defining a second vent axis extending along a second pair of circumferentially opposed outermost vent paths in the first plurality of vent paths and in the second plurality of vent paths, wherein each vent path of the first plurality of vent paths and the second plurality of vent paths are positioned circumferentially within an angular range of the rim defined between the first vent axis and the second vent axis, and wherein the angular range is less than or equal to 45 degrees.

19. The container of claim 18, wherein the bead segment comprises an upwardly-extending member and a downwardly-extending member each extending circumferentially between a first end and a second end, the first end of the upwardly-extending member being proximate the second end of the downwardly-extending member, and the first end of the downwardly-extending member being proximate the second end of the upwardly-extending member, wherein a laterally horizontal axis extends through each of the ends of the upwardly-extending member and a downwardly-extending member, and wherein the first vent axis and the second vent axis are mirrored about the laterally horizontal axis.

20. The container of claim 18, wherein the first plurality of vent paths and the second plurality of vent paths each include at least six vent paths.
